(19) United States
(12) Patent Application Publication
(10) Pub. No.: US 2026/0050246 A1
(43) Pub. Date: Feb. 19, 2026

(54) SHAPE MODEL GENERATION AND USE FOR SEMICONDUCTOR WORKPIECE

(71) Applicant: Wolfspeed, Inc., Durham, NC (US)

(72) Inventors: Edward Van Brunt, Cary, NC (US); Matthew Conrad, Cary, NC (US)

(21) Appl. No.: 18/802,817

(22) Filed: Aug. 13, 2024

(51) Int. Cl. G05B 19/18

(52) U.S. Cl. CPC G05B 19/188; G05B 2219/45031

(57) ABSTRACT

A method of generating a shape model of a semiconductor workpiece. The method includes collecting displacement data across a first surface of the semiconductor workpiece; and generating the shape model of the semiconductor workpiece based on the displacement data. Related methods and apparatus are also provided.

### TECHNICAL FIELD

The present disclosure relates generally to manufacturing semiconductor devices including, without limitation, generating a shape model of a semiconductor workpiece and/or focusing an imaging device using the shape model for the semiconductor workpiece.

### BACKGROUND

Power semiconductor devices are used to carry large currents and support high voltages. A wide variety of power semiconductor devices are known in the art including, for example, transistors, diodes, thyristors, power modules, discrete power semiconductor packages, and other devices. For instance, example semiconductor devices may be transistor devices such as Metal Oxide Semiconductor Field Effect Transistors (“MOSFET”), bipolar junction transistors (“BJTs”), Insulated Gate Bipolar Transistors (“IGBT”), Gate Turn-Off Transistors (“GTO”), junction field effect transistors (“JFET”), high electron mobility transistors (“HEMT”) and other devices. Example semiconductor devices may be diodes, such as Schottky diodes or other devices.

Power semiconductor devices may be packaged into various semiconductor device packages, such as discrete semiconductor device packages and power modules. Power modules may include one or more power devices and other circuit components and can be used, for instance, to dynamically switch large amounts of power through various components, such as motors, inverters, generators, and the like.

Semiconductor devices may be fabricated from workpieces of semiconductor material, such as silicon, sapphire, silicon carbide (SiC), Group III nitride-based semiconductor materials, and/or the like. These materials exhibit many attractive electrical and thermophysical properties, making it suitable for the fabrication of workpieces or substrates for high power density solid state devices, such as power electronic, radio frequency, and optoelectronic devices.

During manufacturing, these materials may have surface or shape features at multiple length scales, from workpiece-sized features down to micron-scale features or sub-micron scale features (e.g., nanometer scale features). For example, usable diameters of SiC wafers can be limited by certain wafer shape characteristics, such as warp, bow, and surface height variation, that can relate to wafer flatness. Moreover, usable diameters, or maximum yield from, SiC wafers can be limited by warped, bowed, or poorly supported SiC wafers. It may be desirable to focus imaging devices and/or characterize the shape features during semiconductor workpiece imaging, processing, analysis, and/or inspection.

As the semiconductor device industry continues to mature, improved modeling of semiconductor workpieces and/or focusing during imaging of semiconductor workpieces is desired. Moreover, accurate shape characterization is essential for semiconductor workpieces for imaging, processing, analysis, and/or inspection of semiconductor workpieces.

The art continues to seek improved modeling and/or imaging techniques for semiconductor workpieces that are capable of overcoming challenges associated with conventional techniques.

### SUMMARY

Aspects and advantages of embodiments of the present disclosure will be set forth in part in the following description, or can be learned from the description, or can be learned through practice of the embodiments.

A method of generating a shape model of a semiconductor workpiece is provided. The method includes collecting displacement data across a first surface of the semiconductor workpiece; and generating the shape model for the semiconductor workpiece based on the displacement data.

The method may further include focusing an image device using the shape model for the semiconductor workpiece.

The displacement data may be collected from a plurality of line scans across the first surface of the semiconductor workpiece.

Collecting displacement data may be collected in an approximately continuous manner along the first surface of the semiconductor workpiece.

The plurality of line scans may include at least two line scans across the first surface of the semiconductor workpiece.

Generating the shape model may include fitting a shape to the semiconductor workpiece based on the displacement data; fitting a mathematical function to height data from the displacement data; and forming a smooth interpolation between the mathematical function and an additional area of the semiconductor workpiece for inclusion in the shape model.

The mathematical function may include a Zernike polynomial of a defined order.

Fitting the mathematical function may be based on at least one of a least squares process and a random sample consensus.

In some embodiments, the method further includes shifting the height data such that a center of the semiconductor workpiece has a cartesian coordinate position of zero on a first cartesian axis and zero on a second cartesian axis; and converting the cartesian coordinate positions of the height data to polar coordinates to obtain polar-converted height data.

In other embodiments, the method further includes sampling the fitted mathematical function on a defined coordinate system; and shifting the defined coordinate system to absolute coordinates of the imaging device in which the semiconductor workpiece is positioned.

The shape model may include a focus map of the semiconductor workpiece.

The Zernike polynomial may include a first tilt along a first cartesian axis and a second tilt along a second cartesian axis, and the method may further include removing the first tilt and the second tilt from the Zernike polynomial to obtain an estimate of at least one of a warp and a bow of the semiconductor workpiece.

The shape model may include image data of the semiconductor workpiece.

In other embodiments, a semiconductor workpiece system is provided. The semiconductor workpiece system includes a workpiece holder configured to hold a semiconductor workpiece; a displacement sensor configured to collect displacement data along a first surface of a semiconductor workpiece; and control circuitry configured to generate a shape model of the semiconductor workpiece based on the displacement data.

The semiconductor workpiece system may further include an image device configured to focus based on the shape model for the semiconductor workpiece.

The displacement sensor may include a confocal chromatic sensor.

The displacement sensor may include at least one of a white light interferometer sensor, a laser sensor, and an ultrasonic sensor.

The displacement data may be collected from a plurality of line scans across the first surface of the semiconductor workpiece.

Generating the shape model with the semiconductor workpiece system may include fit a shape to the semiconductor workpiece based on the displacement data; fit a mathematical function to height data from the displacement data; and form a smooth interpolation between the mathematical function and an additional area of the semiconductor workpiece for inclusion in the shape model.

The mathematical function may include a Zernike polynomial of a defined order.

Fit the mathematical function may be based on at least one of a least squares process and a random sample consensus.

The control circuitry of the semiconductor workpiece system may be further configured to shift the height data such that a center of the semiconductor workpiece has a cartesian coordinate position of zero on a first cartesian axis and zero on a second cartesian axis; and convert the cartesian coordinate positions of the height data to polar coordinates to obtain polar-converted height data.

The control circuitry of the semiconductor workpiece system may be further configured to sample the fitted mathematical function on a defined coordinate system; and shift the defined coordinate system to absolute coordinates of the imaging device in which the semiconductor workpiece is positioned.

The shape model may include a focus map of the semiconductor workpiece.

The Zernike polynomial may include a first tilt along a first cartesian axis and a second tilt along a second cartesian axis; and the control circuitry of the semiconductor workpiece system may be further configured to remove the first tilt and the second tilt from the Zernike polynomial to obtain an estimate of at least one of a warp and a bow of the semiconductor workpiece.

The shape model may include image data of the semiconductor workpiece.

In yet other embodiments, a method of generating image data of a semiconductor workpiece is provided. The method includes collecting displacement data across a first surface of the semiconductor workpiece; and generating the image data of a shape of the semiconductor workpiece based on the displacement data.

In some embodiments, the method further includes processing the image data to obtain information about the semiconductor workpiece including at least one of an inspection result for the semiconductor workpiece, information used in processing of the semiconductor workpiece, and a characteristic of the semiconductor workpiece.

The characteristic of the semiconductor workpiece may include at least one of a warp and a bow of the semiconductor workpiece with a tilt of the semiconductor workpiece removed.

In still other embodiments, a semiconductor workpiece system is provided, The semiconductor workpiece system includes a workpiece holder configured to hold a semiconductor workpiece; a displacement sensor configured to collect displacement data along a first surface of a semiconductor workpiece; and control circuitry configured to generate the image data of a shape of the semiconductor workpiece based on the displacement data.

The control circuitry of the semiconductor workpiece system may be further configured to process the image data to obtain information about the semiconductor workpiece including at least one of an inspection result for the semiconductor workpiece, information used in processing of the semiconductor workpiece, and a characteristic of the semiconductor workpiece.

The characteristic of the semiconductor workpiece may include at least one of a warp and a bow of the semiconductor workpiece with a tilt of the semiconductor workpiece removed.

In yet other embodiments, a method of focusing an imaging device on a semiconductor workpiece is provided. The method includes focusing the image device on the semiconductor workpiece using a shape model for the semiconductor workpiece based on displacement data, from a displacement sensor, across a first surface of the semiconductor workpiece.

The shape model may include a focus map of the semiconductor workpiece.

The displacement data may be collected from a plurality of line scans across the first surface of the semiconductor workpiece.

The displacement data may be approximately continuous along the first surface of the semiconductor workpiece.

The plurality of line scans can include at least two line scans across the first surface of the semiconductor workpiece.

In some embodiments, the method further includes generating the shape model based on fitting a shape to the semiconductor workpiece based on the displacement data; fitting a mathematical function to height data from the displacement data; and forming a smooth interpolation between the mathematical function and an additional area of the semiconductor workpiece for inclusion in the shape model.

The mathematical function may include a Zernike polynomial of a defined order.

Fitting the mathematical function may be based on at least one of a least squares process and a random sample consensus.

In some embodiments, the method further includes shifting the height data such that a center of the semiconductor workpiece has a cartesian coordinate position of zero on a first cartesian axis and zero on a second cartesian axis; and converting the cartesian coordinate positions of the height data to polar coordinates to obtain polar-converted height data.

In some embodiments, the method further includes sampling the fitted mathematical function on a defined coordinate system; and shifting the defined coordinate system to absolute coordinates of the imaging device in which the semiconductor workpiece is positioned.

The Zernike polynomial may include a first tilt along a first cartesian axis and a second tilt along a second cartesian axis, and the method may further include removing the first tilt and the second tilt from the Zernike polynomial to obtain an estimate of at least one of a warp and a bow of the semiconductor workpiece.

In still other embodiments, a semiconductor workpiece imaging system is provided. The semiconductor workpiece imaging system includes a workpiece holder configured to hold a semiconductor workpiece; a displacement sensor configured to collect displacement data along a first surface of a semiconductor workpiece; and control circuitry configured to generate a shape model for the semiconductor workpiece based on the displacement data and to focus an image device on the semiconductor workpiece using the shape model for the semiconductor workpiece. The shape model may include a focus map of the semiconductor workpiece.

The displacement data may be collected from a plurality of line scans across the first surface of the semiconductor workpiece.

Collecting may include collecting displacement data in an approximately continuous manner along the first surface of the semiconductor workpiece.

The plurality of line scans can include at least two line scans across the first surface of the semiconductor workpiece.

Generating the shape model may include: fitting a shape to the semiconductor workpiece based on the displacement data; fitting a mathematical function to height data from the displacement data; and forming a smooth interpolation between the mathematical function and an additional area of the semiconductor workpiece for inclusion in the shape model.

The mathematical function may include a Zernike polynomial of a defined order.

Fitting the mathematical function may be based on at least one of a least squares process and a random sample consensus.

In some embodiments, the control circuitry is further configured to shift the height data such that a center of the semiconductor workpiece has a cartesian coordinate position of zero on a first cartesian axis and zero on a second cartesian axis; and convert the cartesian coordinate positions of the height data to polar coordinates to obtain polar-converted height data.

In some embodiments, the control circuitry is further configured to sample the fitted mathematical function on a defined coordinate system; and shift the defined coordinate system to absolute coordinates of the imaging device in which the semiconductor workpiece is positioned.

The Zernike polynomial may include a first tilt along a first cartesian axis and a second tilt along a second cartesian axis, and the control circuitry may be further configured to remove the first tilt and the second tilt from the Zernike polynomial to obtain an estimate of at least one of a warp and a bow of the semiconductor workpiece.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF DRAWINGS

FIG. 1 depicts a flow chart of an example method according to example embodiments of the present disclosure.

FIG. 2 is a block diagram illustrating an example of a shape model or semiconductor workpiece displacement information generation system according to embodiments of the present disclosure;

FIG. 3A is a block diagram illustrating an example of a semiconductor workpiece imaging system according to embodiments of the present disclosure.

FIG. 3B is a block diagram illustrating an example of a semiconductor workpiece processing system according to embodiments of the present disclosure.

FIG. 4 depicts an example semiconductor workpiece imaging system according to example embodiments of the present disclosure.

FIG. 5 depicts an example semiconductor workpiece imaging system according to example embodiments of the present disclosure.

FIG. 6 depicts the example semiconductor workpiece imaging system of FIG. 5 according to example embodiments of the present disclosure.

FIG. 7 illustrates example sample lines of a pattern across a first surface of a semiconductor workpiece according to example embodiments of the present disclosure.

FIG. 8 is a graph that illustrates an example of one line scan of data collected along one sample line of FIG. 7 according to example embodiments of the present disclosure.

FIG. 9 illustrates an example of Zernike polynomials.

FIG. 10 illustrates an example circle fit to a semiconductor workpiece according to example embodiments of the present disclosure.

FIG. 11 illustrates an example plot of shifted height data of a semiconductor workpiece according to example embodiments of the present disclosure.

FIG. 12 illustrates an example plot of height data from FIG. 11 transformed into height data with polar coordinates according to example embodiments of the present disclosure.

FIG. 13 illustrates an example of absolute height data from a line scan of a semiconductor workpiece coordinates according to example embodiments of the present disclosure.

FIG. 14 illustrates an example shape model after shifting back to machine coordinates according to example embodiments of the present disclosure.

FIG. 15 illustrates the shape model from FIG. 14 after forming the smooth interpolation according to example embodiments of the present disclosure.

FIGS. 16A-16B depict example images of a shape model of only higher-order terms of Zernike polynomial according to example embodiments of the present disclosure.

FIG. 17 depicts a flow chart of an example method according to example embodiments of the present disclosure.

Repeat use of reference characters in the present specification and drawings is intended to represent the same and/or analogous features or elements of the present disclosure.

### DETAILED DESCRIPTION

Embodiments of the inventive concepts are explained more fully with reference to the non-limiting aspects and examples that are described and/or illustrated in the accompanying drawings and detailed in the following description. It should be noted that the features illustrated in the drawings are not necessarily drawn to scale, and features of some embodiments may be employed with other aspects as the skilled artisan would recognize, even if not explicitly stated herein. Descriptions of well-known components and processing techniques may be omitted so as to not unnecessarily obscure the aspects of the disclosure. The examples used herein are intended merely to facilitate an understanding of ways in which the disclosure may be practiced and to further enable those of skill in the art to practice the aspects of the disclosure. Accordingly, the examples and aspects herein should not be construed as limiting the scope of the disclosure, which is defined solely by the appended claims and applicable law. Moreover, it is noted that like reference numerals represent similar parts throughout the several views of the drawings.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the another element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the another element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element or region to another element or region as illustrated in the Figures. It will be understood that these terms and those discussed above are intended to encompass different orientations of the device in addition to the orientation depicted in the Figures.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art.

Semiconductor devices may be manufactured by performing imaging, fabrication, inspection, and/or analysis processes on a semiconductor workpiece. A semiconductor workpiece may be a semiconductor wafer, which is a thin, disc-shaped sheet of semiconductor material (e.g., silicon (Si), silicon carbide (SiC), gallium nitride (GaN), etc.) that may serve as the foundation for manufacturing semiconductor devices, such as integrated circuits (ICs) and/or other electronic components. In some examples, a power semiconductor device (e.g., MOSFET, JFETs, Schottky diode, HEMT device, etc.) may be fabricated on a monocrystalline silicon carbide-based semiconductor workpiece, which may serve as a substrate for the power semiconductor device.

Aspects of the present disclosure are discussed with reference to a semiconductor workpiece that is a semiconductor wafer that includes SiC (e.g., a “silicon carbide semiconductor wafer” or “wafer”) for purposes of illustration and discussion. Those having ordinary skill in the art, using the disclosures provided herein, will understand that aspects of the present disclosure can be used with other semiconductor workpieces. Other workpieces may include carrier substrates, ingots, boules, polycrystalline substrates, monocrystalline substrates, bulk crystalline material, etc.

Certain approaches for imaging a semiconductor workpiece, for example, may include a focus or autofocus process that lacks an ability to accurately and/or efficiently focus on the semiconductor workpiece. Semiconductor workpieces may include various shape characteristics, such as an approximate circular shape and an uneven surface or other surface morphology of the semiconductor workpiece. Some approaches may have difficulty focusing, or maintaining focus, on a semiconductor workpiece. Moreover, some approaches may not account for a shape or a tilt of the semiconductor workpiece. For example, a semiconductor workpiece may include a warp or bow. Additionally or alternatively, a warp or bow in the shape of the semiconductor workpiece may be introduced by an apparatus holding the semiconductor workpiece, etc. Some approaches may lack an ability to accurately and/or efficiently take into account a shape or tilt of the semiconductor workpiece in connection with imaging, inspection, processing, or analysis of the semiconductor workpiece.

A variety of factors related to the imaging systems and/or the imaging conditions may introduce inaccuracies in images or an imaging process of a semiconductor workpiece. In a semiconductor workpiece system involving a microscope to generate images of a wafer surface for inspection, for example, typically the magnification of the system is high enough that either the wafer or objective needs to be translated with respect to the other surface in order to maintain focus. As a consequence, error may be introduced in the autofocusing and/or the accuracy of the resulting image data may not be sufficient.

Moreover, an imaging process for a semiconductor workpiece can fail. For example, an approach using a laser autofocus can include a real-time control loop. When an outlier data point, e.g., corresponding to a defect such as a scratch on a surface of the semiconductor workpiece, is included for a semiconductor workpiece, the real-time control loop may oscillate and become unstable while trying to focus on the scratch. As a consequence, the system may go out of focus and/or fail.

For example, in one approach for trying to maintain focus using a laser autofocus, defocus and other errors may be introduced. A laser beam may be directed through an objective lens of the system and reflects off of the wafer, and back into an autofocus light path over a knife edge or other narrow aperture. Based on the returned signal, the system may be capable of finding an optimal focus. The focus error signal can be sent to a Z-actuator through a control loop to minimize the amount of defocus observed. Due to the difference in reflectivity of samples, however, such systems can require per-wafer calibration based on contrast-detect autofocus; and if the wafer has varying reflectivity, sometimes laser-based autofocus can fail and require recalibration within a single sample.

Another approach for trying to maintain focus may use contrast-detect focus map creation. An area of the wafer with a known pattern is moved under the objective and Z is swept. Based on image metrics (such as the integrated value of a sobel filter applied to each image captured), a “quality vs. Z” curve is generated, and the optimal focus for each point may be picked based on the peak of this curve. This may be repeated for many sites across the wafer, and generates a map that can be interpolated to get the Z-position of an arbitrary site on the wafer. This procedure, however, typically may be slow as it requires multiple image captures, and can be difficult to apply if there is no known pattern on the wafer.

Another approach may use confocal focus map creation based on collection of discrete data points and linear interpolation of the discrete data points. When a confocal pinhole or slit is present in the system, the contrast detect method can be applied, but instead of a metric such as pattern quality, absolute brightness can be used. In another approach, a focus map may be created with a displacement sensor based on collection of discrete data points. Similar to contrast detect autofocus, an auxiliary sensor such as a confocal chromatic or white light interferometer can be used for focus map creation, so long as the relative Z-position between the displacement sensor and objective lens is known, as well as the X and Y offset.

A potential drawback of such focus map approaches is that the created focus map may not have acceptable fidelity or accuracy (e.g., mathematical accuracy) because the focus map may be created based on discrete nearest neighbor data points and linear interpolation of the discrete data points. Additionally, bad or deficient discrete data points may be included, from a scratch on the wafer for example, which may cause an autofocus (e.g., a laser autofocus) to fail. Moreover, the shape of the wafer (e.g., a circle or approximately a circle) may not be taken into account in such a process; and the physics of the way a semiconductor wafer is expected to deform when held in the system may not be respected in such approaches.

Accordingly, example aspects of the present disclosure are directed to semiconductor workpiece systems and methods operable to collect displacement data across a first surface of the semiconductor workpiece; and generate a shape model for the semiconductor workpiece based on the displacement data. An imaging device may be focused using the shape model of the semiconductor workpiece.

Aspects of the present disclosure provide a number of technical effects and benefits, including improvements to computing technology and/or semiconductor modeling, imaging, processing, inspection and analysis technology. Accuracy, efficiency, and detail of focusing of an imaging device, for example, may be improved, and system- and hardware-related issues described above may be addressed. The shape model of the present disclosure has a greater accuracy, robustness, stability and/or speed than other approaches. Moreover, use of the shape model in focusing an image device, and/or in processing, analyzing or inspecting the semiconductor workpiece has a greater accuracy, robustness, stability and/or speed than other approaches.

Moreover, by including displacement data collection (e.g., near continuous motion and data sampling) across a first surface of the semiconductor workpiece, fewer acceleration and deceleration events may be needed for wafer movement than in processes that includes discrete acceleration and deceleration events for discrete data points.

Moreover, the shape model for the semiconductor workpiece based on the displacement data may have improved fidelity or accuracy (e.g., mathematical accuracy) because, e.g., it is not based on discrete nearest neighbor data points and linear interpolation of discrete data points. Additionally, bad or deficient data points may be omitted, e.g., from a scratch on the semiconductor workpiece. Thus, an imaging system may continue to perform despite bad or deficient data points, for example. Further, a shape of the semiconductor workpiece (e.g., a circle or approximately a circle) may be taken into account while generating the shape model and/or in connection with processing, inspection, or analysis of the semiconductor workpiece. As a consequence, the physics of the way a semiconductor workpiece is expected to deform when held in the system may be respected.

Thus, example aspects of the present disclosure provide focusing of an imaging device using the shape model for semiconductor workpiece and/or provide processing, inspection, or analysis of the semiconductor workpiece based on the shape model, with greater sensitivity important to the semiconductor imaging and manufacturing process.

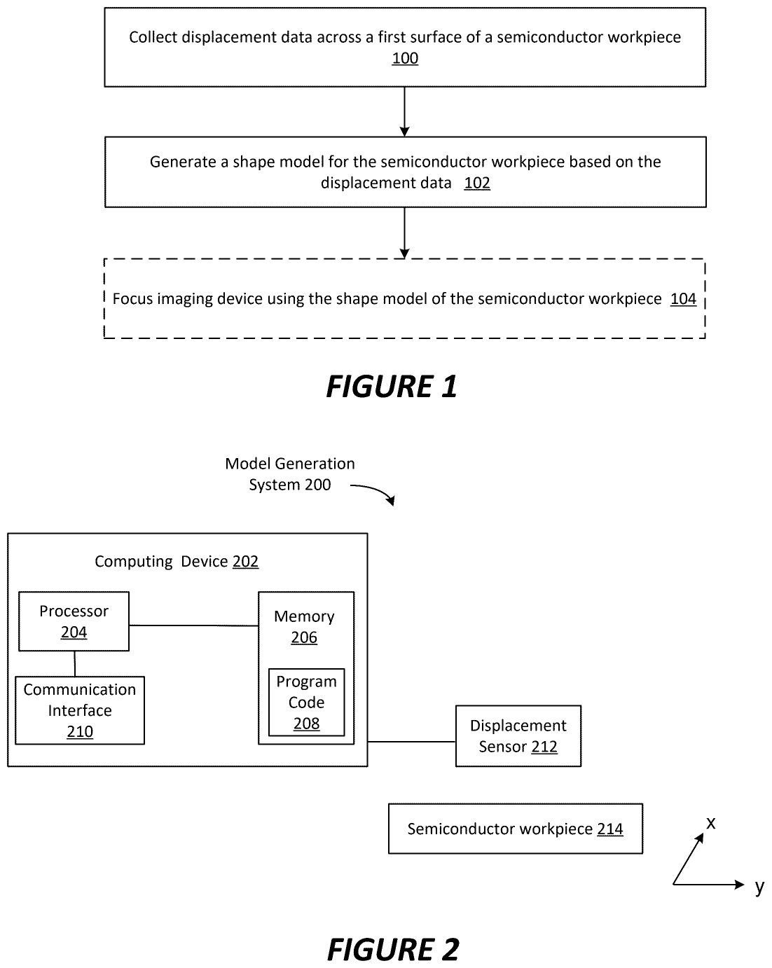

More particularly, as discussed in greater detail herein, an example method is discussed with reference to FIG. 1. FIG. 1 depicts example process steps for purposes of illustration and discussion. Those having ordinary skill in the art, using the disclosures provided herein, will understand that the process steps of any of the methods described in the present disclosure may be adapted, modified, include steps not illustrated, omitted, and/or rearranged without deviating from the scope of the present disclosure.

The method includes a method of generating a shape model of a semiconductor workpiece. At 100, displacement data is collected across a first surface of the semiconductor workpiece. At 102, the shape model for the semiconductor workpiece is generated based on the displacement data. Additionally or alternatively, the method further includes focusing 104 the image device using the shape model of the semiconductor workpiece.

A system for generating the shape model or other workpiece displacement information to a semiconductor workpiece imaging device for use in auto focusing or other semiconductor workpiece processing, as illustrated in the example of a system 200 in FIG. 2. FIG. 2 includes a computing device 202, a displacement sensor 212, and a semiconductor workpiece 214. While the computing device 202 in FIG. 2 is shown as a separate device from the displacement sensor 212, it will be understood that the displacement sensor 212 instead may be included in the computing device 202. The shape model can include an image(s) of the shape of the semiconductor workpiece or image data (e.g., without an image being generated). Additionally, while displacement sensor 212 is shown as a wired connected to computing device 202, it will be understood that the connection may be a wired connection or a wireless connection.

This example includes the displacement sensor 212 and the semiconductor workpiece 214 where a translation mechanism can move the surface of the semiconductor workpiece 214 and/or the displacement sensor 212 relative to each other in an x-y plane. Movement relative to each other in the x-y plane can be done to produce a shape model or other semiconductor workpiece displacement information for a semiconductor workpiece imaging device for use in auto focusing or other semiconductor workpiece processing.

In particular, displacement data is collected with displacement sensor 212 across a first surface of the semiconductor workpiece 214. The displacement sensor 212 may include depth sensors such as one or more surface measurement lasers or other illuminators (e.g., confocal chromatic sensor (CCS)) or sensors (e.g., white light interferometer sensor, a laser sensor, and an ultrasonic sensor, and/or the like) that may be operable to emit a laser or other light onto the surface of the semiconductor workpiece 214 and scan the surface (e.g., based on reflections of the light) for height or depth measurements, topography measurements, etc. of the surface of the semiconductor workpiece 214. The displacement sensor 212 in this example may be configured to measure an amount of movement that occurs between the semiconductor workpiece 214 and the displacement sensor 212. It should be understood that the displacement sensor 214 may be any suitable sensor operable to obtain displacement data described herein for generating the shape model or semiconductor workpiece displacement information for the semiconductor workpiece 214 without deviating from the scope of the present disclosure. It also should be understood that more than one displacement sensor 214 may be included to collect the displacement data.

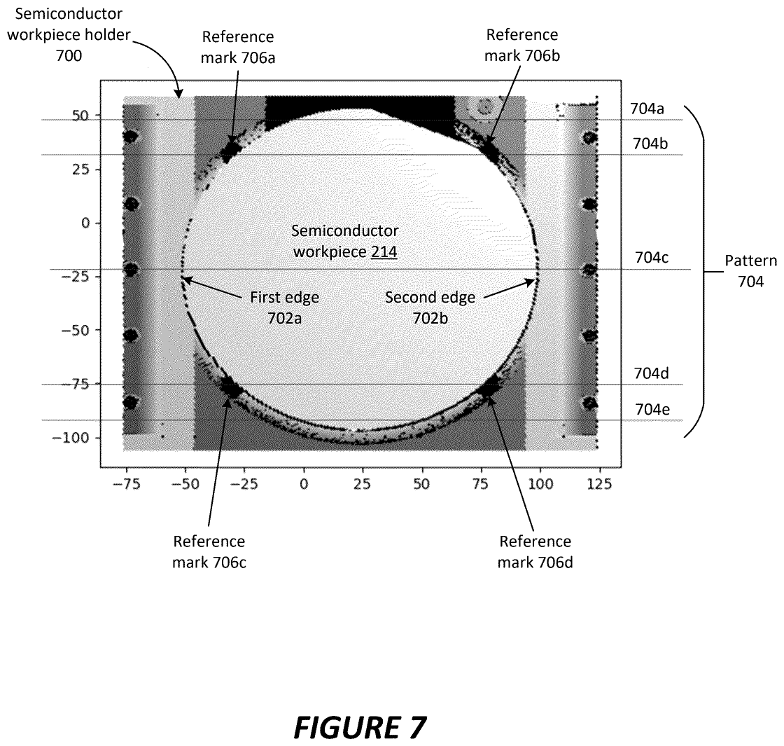

The displacement data in this example is provided to computing device 202. As discussed further herein with reference to the example in FIGS. 7-15, computing device 202 can generate the shape model or semiconductor workpiece displacement information for the semiconductor workpiece 214 based on the displacement data, that can be provided to a semiconductor workpiece imaging device for use in auto focusing or other semiconductor workpiece processing.

The computing device 202 includes at least one processor 204, a memory 206 that include program code 208, a communication interface 210, and a power source (not shown). The computing device 202 may be composed of multiple physically separate components (e.g., a processing circuitry component, a memory component, etc.), which each may have their own respective components. The computing device 202 also may include multiple sets of the various illustrated components for different wireless technologies integrated into computing device 202, for example WiFi or Bluetooth wireless technologies. These wireless technologies may be integrated into the same or different ship or set of chips and other components within computing device 202.

The at least one processor 204 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, cither alone or in conjunction with other computing device 202 components, such as the memory 206, to provide computing device 202 functionality.

The memory 206 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the at least one processor 204. The memory 206 may store any suitable instructions, data, or information, including a computer program, software, an application including one or more of logic, rules, code, tables, and/or other instructions capable of being executed by the at least one process or 204 and utilized by the computing device 202. The memory 206 may be used to store any calculations made by the at least one processor 204 and/or any data received via the communication interface 210. In some embodiments, the at least one processor 204 and memory 206 are integrated.

The communication interface 210 is used in wired or wireless communication of signaling and/or data (e.g., displacement data) between the computing device 202 and other devices as discussed herein. The communication interface 210 can comprise port(s)/terminal(s) to send and receive data, for example to and from displacement sensor 212. The data may be passed to the at least one processor 204. In other embodiments, the communication interface 210 may comprise different components and/or different combinations of components.

Embodiments of the computing device 202 and/or displacement sensor 212 may include additional components beyond those shown in FIG. 2 for providing certain aspects of the computing device and/or displacement sensor's functionality, including any of the functionality described herein and/or any functionality necessary to support the subject matter described herein.

As discussed further herein, the shape model or other semiconductor workpiece displacement information may be used by control circuitry 204, 206, 208, and/or 210 of computing device 202 or control circuitry of a semiconductor workpiece system for use in auto focusing or to inspect, process, or analyze the semiconductor workpiece 214. For example, the control circuitry may analyze a surface morphology of the semiconductor workpiece 214 or make a decision with respect to the semiconductor workpiece 214 (e.g., wafer pass/fail based on a warp or bow of the semiconductor workpiece).

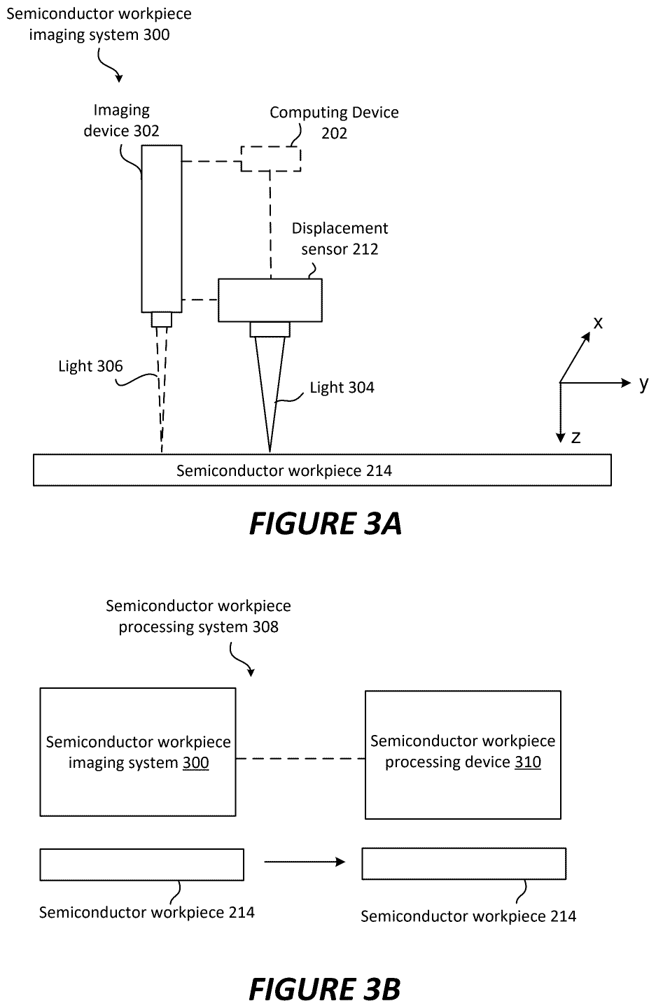

Other examples can include a semiconductor workpiece imaging system 300 as shown in FIG. 3A. The semiconductor workpiece imaging system 300 can include an imaging device 302. The imaging device 302 may be communicatively connected to computing device 202 and/or displacement sensor 212. Imaging device 302 can image a surface or interior of semiconductor workpiece 214 using a light or radiation source (not shown). Displacement sensor 212 is configured to provide displacement data/information either directly or through computing device 202. Computing device 202 can use the displacement data/information to calculate a shape model of semiconductor workpiece 214, and/or to focus imaging device 302 either directly without generating the shape model or with the shape model.

An imaging device, such as imaging device 302, can include a camera, a microscope, an X-Ray imaging device, an acoustic optical device (AOD) scanned laser that is detected with a photomultiplier tube, or other similar device.

FIG. 3B is a block diagram illustrating an example semiconductor workpiece processing 308 system that includes imaging system 300 and a semiconductor workpiece processing device 310. While the example shown in FIG. 3B shows semiconductor workpiece processing device 310 as a separate device from the semiconductor workpiece imaging system 300, examples herein are not so limited. For example, the imaging system 300 and the semiconductor workpiece processing device 310 can be included in a single device or multiple devices.

The semiconductor workpiece processing device 310 may include components for semiconductor workpiece processing, such as wafer separation, grinding, polishing, inspection, etc. The imaging system 300 and/or semiconductor workpiece processing device 308 also can include computing device 202 and displacement sensor 212, or the functionality of computing device 202 and displacement sensor 212, to collect displacement data from displacement sensor 212 across a first surface of the semiconductor workpiece 214; generate a shape model for the semiconductor workpiece 214 based on the displacement data; and/or focus the image device 302 on the semiconductor workpiece 214 using the displacement information or the shape model for the semiconductor workpiece. The shape model can include a focus map for the semiconductor workpiece 214. Additionally or alternatively, the displacement information or the shape model of the semiconductor workpiece 214 may be used, for example, to process, analyze, and/or inspect semiconductor workpiece 214 at semiconductor workpiece processing device 308.

As shown, FIGS. 3A and 3 include imaging system 300 which can include a displacement sensor 212 and a translation stage moving the imaging device 302 and/or displacement sensor 212 in one or more of x-y-z axes. The displacement sensor 212 of examples herein can be used to collect the displacement data from displacement sensor 212. The displacement data can be collected from a plurality of line scans across the first surface of the semiconductor workpiece 214, for example. The displacement data can be collected in an approximately continuous manner along the first surface of the semiconductor workpiece 214. The plurality of line scans can include at least two line scans across the first surface of the semiconductor workpiece 214.

A shape model or semiconductor workpiece displacement information can be generated, by computing device 202 for example, for the semiconductor workpiece 214 based on the displacement data. Image device 302, and/or a semiconductor workpiece processing device 308 that includes imaging device 302/displacement sensor 212, can be focused on semiconductor workpiece 214 using the displacement information or the shape model for the semiconductor workpiece 214. Additionally or alternatively, the displacement data and/or the shape model can be used for other workpiece processing, such as with a semiconductor workpiece processing device 308 for inspecting, processing, or analyzing semiconductor workpiece 214.

As discussed, the collection of displacement data in some examples includes continuous, or near continuous, motion and displacement data collection from at least one displacement sensor 212. In an example discussed further herein with respect to FIGS. 7-15, five acceleration and five deceleration events are used for wafer movement in an imaging system. This is in contrast, for example, to a thirty (30) point focus map of other approaches based on discrete data points where thirty (30) acceleration and deceleration events may be needed, and which likely may have lower fidelity based on linear interpolation between the discrete data points.

As discussed, data may be collected from a displacement sensor 212 from a plurality of line scans across the first surface of the semiconductor workpiece. Collecting displacement data may be performed in an approximately continuous manner along the first surface of the semiconductor workpiece. In some embodiments, the plurality of line scans include at least two line scans across the first surface of the semiconductor workpiece.

The imaging device 302 may include a light source. The light source may be configured to direct light 306 at a semiconductor workpiece 214.

As discussed, the semiconductor workpiece imaging system 300 of FIGS. 3A, 3B may include one or more displacement sensors 212 for obtaining displacement data associated with the semiconductor workpiece 214. The computing device 202 can use the displacement data/information alone, or can generate the shape model or semiconductor workpiece displacement information, and focus the image device 302 on the semiconductor workpiece 214 using the displacement data and/or shape model for the semiconductor workpiece 214. The shape model or semiconductor workpiece displacement information can include workpiece characterization data for the semiconductor workpiece 214. Workpiece characterization data is data that provides information associated with the semiconductor workpiece 214, such as topography, surface roughness, presence of anomalies, height data of a first surface across the semiconductor workpiece, and/or other characteristics. Workpiece characterization data may include, for instance, an image of the surface of the semiconductor workpiece 214 and/or a topological map of the surface of the semiconductor workpiece 214.

In some embodiments, the one or more displacement sensors 212 may include depth sensors such as one or more surface measurement lasers or other illuminators (e.g., CCS) or sensors (e.g., white light interferometer sensor, a laser sensor, and an ultrasonic sensor, and/or the like) that may be operable to emit a laser or other light 310 onto the surface of the semiconductor workpiece 214 and scan the surface (e.g., based on reflections of the light) for height or depth measurements, topography measurements, etc. of the surface of the semiconductor workpiece 214. In the example in FIG. 3A, the one or more displacement sensors 212 may be configured to measure an amount of movement that occurs between the semiconductor workpiece 214 and imaging device 302 and/or displacement sensor 212. It should be understood that the one or more displacement sensors 212 may be any suitable sensor operable to obtain displacement data described herein, generate the shape model or semiconductor workpiece displacement information for the semiconductor workpiece 214 based on the displacement data, and focus an image device on a semiconductor workpiece using the shape model for the semiconductor workpiece without deviating from the scope of the present disclosure.

The semiconductor workpiece 214 may have a front face/surface and a back face/surface opposite the front face. The front face may be proximal the displacement sensor 212. The light source may direct incident light 306 onto a first portion of the semiconductor workpiece 214.

Incident light 306 may be reflected and/or transmitted by the semiconductor workpiece 214, resulting in detectable light 304 that is detected by the displacement sensor 212. Detectable light 304 may be reflected light for purposes of illustration and discussion. Those having ordinary skill in the art, using the disclosures provided herein, will understand that the detectable light 304 may be transmitted light. Additionally or alternatively, the detectable light 304 may be emitted by the semiconductor workpiece 214 as photoluminescence (e.g., fluorescence). For instance, the incident light 306 may excite respective portions of the semiconductor workpiece 214 and result in a delayed light emission by the semiconductor workpiece 214.

The light source may be configured to emit light that is polarized (e.g., elliptically, linearly) or unpolarized, pulsed or continuous, coherent or incoherent, visible or invisible, and/or light of one or more wavelengths or wavelength ranges.

The imaging device 302 may obtain workpiece images from the surface of the semiconductor workpiece 214.

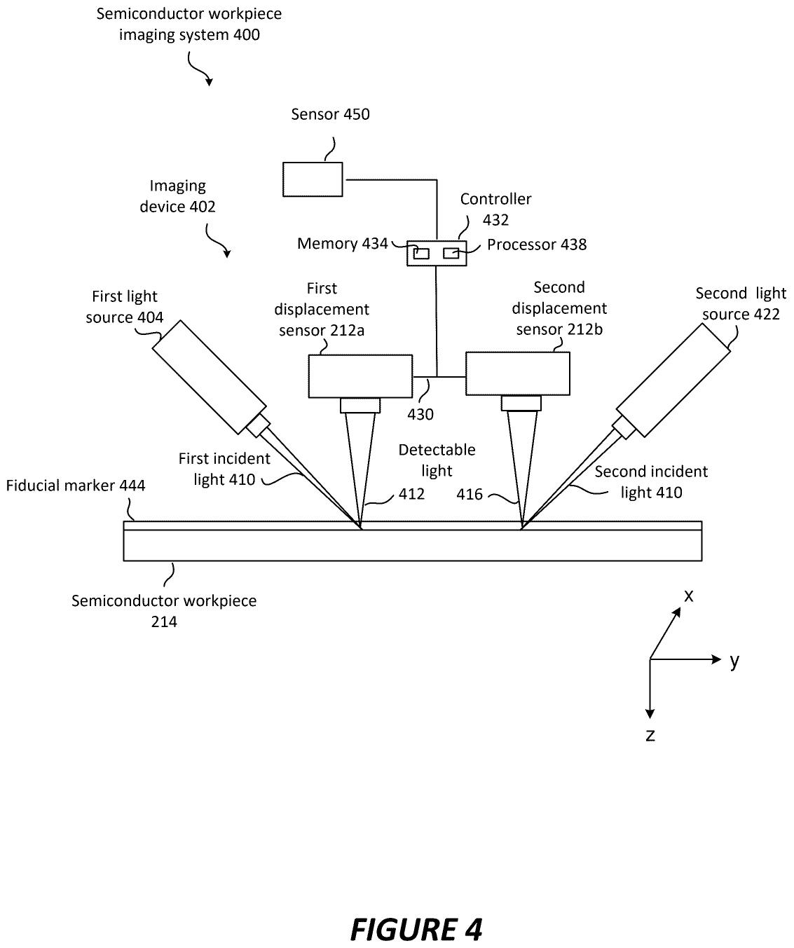

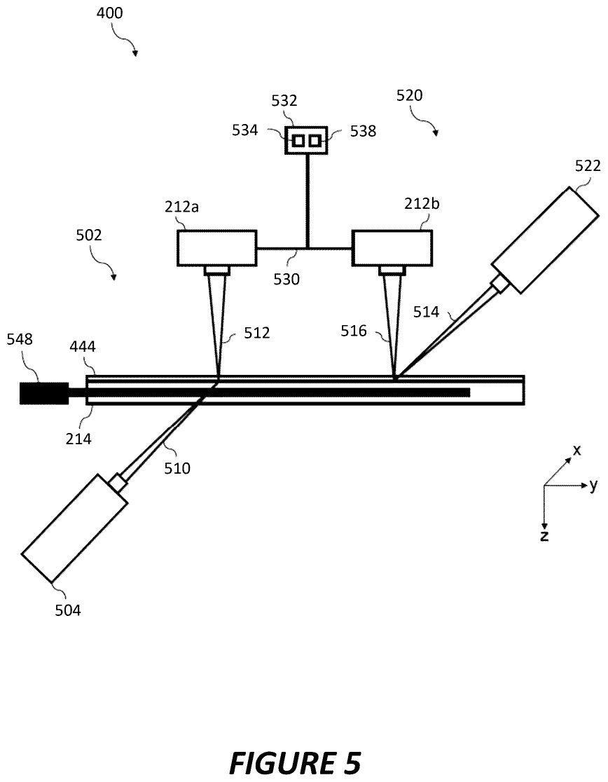

In some examples, the semiconductor workpiece imaging system 300 includes a fiducial structure 444. The fiducial structure 444 may be on the semiconductor workpiece 214 and/or on a workpiece holder (not shown in FIGS. 3A or 3B, but see semiconductor workpiece 214 of FIG. 4, workpiece holder 548 of FIG. 5 and workpiece holder 700 in FIG. 7). The fiducial structure 444 may be configured to be visible by one or more of the imaging device 302. The fiducial structure 444 may be etched into, layered on (e.g., using evaporation), attached to, or otherwise formed as part of the semiconductor workpiece 214 and/or the workpiece holder. The fiducial structure 444 may include one or more fiducial markers individually identifiable by the imaging device 302.

The workpiece holder 548, 700 may include a receptacle operable to receive the workpiece. It should be understood that the workpiece holder may be similar to any of the workpieces described herein, such as the semiconductor workpiece holder 548 (FIG. 5) or the semiconductor workpiece holder 700 (FIG. 7), and/or the like.

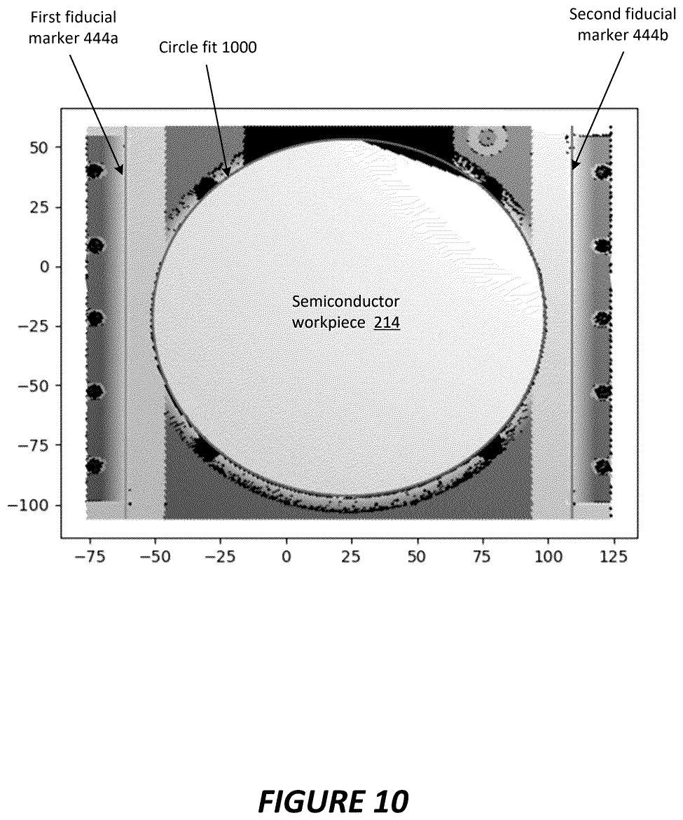

The workpiece holder 548, 700 may also include one or more fiducial structures 444, such as a first fiducial marker 444a and a second fiducial marker 444b (collectively “fiducial marker(s) 444”) shown in FIG. 10. Those having ordinary skill in the art, using the disclosures provided herein, will appreciate that the fiducial marker 444 may be similar to any of the fiducial structures described herein, such as the fiducial structure 444 (FIG. 4), the fiducial structure 444 (FIG. 5), the fiducial markers 444a, 444b (FIG. 10) and/or the like. In some examples, each fiducial structure 444 may be on a peripheral side of the workpiece holder 548, 700. For instance, as shown in FIG. 10, the first fiducial structure 444a may be on a peripheral side of the workpiece holder 700, and the second fiducial structure 444b may be on an opposing peripheral side of the workpiece holder 700 from the first fiducial structure 444a. Put differently, the workpiece holder 700 may be configured such that the receptacle and, hence, the workpiece 214 may be between the first fiducial structure 444a and the second fiducial structure 444b.

The fiducial structures 444 may include the workpiece 214. By way of non-limiting example, the semiconductor workpiece 214 may include a wide bandgap semiconductor, such as SiC. However, those having ordinary skill in the art, using the disclosures provided herein, will appreciate that the semiconductor workpiece 214 may include any suitable semiconductor material without deviating from the scope of the present disclosure. In some examples, each of the one or more fiducial markers 444 may include at least one of an ArUco pattern, an AprilTag pattern, a CALTag pattern, an ARTag pattern, and/or the like. It should be understood that the fiducial structures 444 are depicted as having one column of fiducial markers along lines 444a, 444b for purposes of illustration and discussion. Those having ordinary skill in the art, using the disclosures provided herein, will understand that a fiducial structure of the present disclosure may include any number of fiducial markers having any suitable pattern without deviating from the scope of the present disclosure.

As described herein, the fiducial structures 444 may be used by an imaging system (e.g., imaging device 302 (FIGS. 3A, 3B), semiconductor workpiece imaging system 400 (FIG. 4), or a semiconductor workpiece imaging system 400 (FIGS. 4-5)) to identify the semiconductor workpiece 214 versus the holder 548, 700; to detect the edges of the semiconductor workpiece 214; and/or to collect displacement data including sample heights of the fiducial markers 444.

In some embodiments, a focus map is created using the collected displacement data (e.g., collected from a confocal chromatic sensor), rather than linearly interpolated discrete data points. Thus, the physics of the way a semiconductor wafer is expected to deform when held in a system are respected, and the resulting focus map may have high fidelity compared to approaches that use interpolation of discrete data points.

Some embodiments herein for creating a shape model that comprises a focus map are performed offline, outside a real-time control loop. Thus, in contrast to other approaches based on a real-time control loop which can become unstable, creation of the focus map of some embodiments remains stable.

In some embodiments, outlier data points collected from the displacement data may not reduce accuracy of the focus map based on the availability of a robust amount of non-outlier data collected (e.g., 10,000-30,000 data points collected along a pattern or a line scan); and/or may not cause the method to fail because such outlier data points may be discarded.

It should be noted that, although some examples are described herein with reference to semiconductor workpiece imaging systems, aspects of the present disclosure may be implemented in any suitable model generation system, imaging, inspection, manufacturing or processing system. Those having ordinary skill in the art, using the disclosures provided herein, will understand that the systems and methods described herein are not limited to collecting displacement data and/or generating a shape model or semiconductor workpiece displacement information by a computing device of a system, and may be applicable to collecting displacement data, generating a shape model or semiconductor workpiece displacement information, and using the shape model or semiconductor workpiece displacement information in any suitable imaging, processing, analysis, manufacturing, and/or inspection semiconductor workpiece system.

Another example that includes additional components is shown in FIG. 4. FIG. 4 depicts an example semiconductor workpiece imaging system 400 according to example embodiments of the present disclosure. It should be understood that FIG. 4 is intended to represent structures for purposes of identification and description and is not intended to represent the structures to physical scale.

The semiconductor workpiece imaging system 400 can include controller 432 comprising the functionality of computing device 202 and first and/or second displacement sensors 212a, 212b to collect the displacement data, generate the shape model or semiconductor workpiece displacement information, and/or focus the image device 402 on the semiconductor workpiece 214 using the shape model for the semiconductor workpiece 214. Additionally or alternatively, the shape model or semiconductor workpiece displacement information of the semiconductor workpiece 214 may be used, for example, to process, analyze, and/or inspect semiconductor workpiece 214.

The semiconductor workpiece imaging system 400 may include a first imaging device 402 and a second imaging device 420. The controller 432 includes control circuitry. The first imaging device 402 may include a first light source 404 and a second light source 422. The first light source 404 and/or the second light source 422 may be configured to direct light at a semiconductor workpiece 214.

As discussed, the semiconductor workpiece imaging system 400 may include one or more displacement sensors 212a, 212b for obtaining displacement data associated with the semiconductor workpiece 214. The controller 432 can use the displacement data to generate the shape model or semiconductor workpiece displacement information. The shape model or semiconductor workpiece displacement information can include workpiece characterization data for the semiconductor workpiece 214.

In some embodiments, the one or more displacement sensors 212a, 212b may include depth sensors such as one or more surface measurement lasers or other illuminators (e.g., CCS) or sensors (e.g., white light interferometer sensor, a laser sensor, and an ultrasonic sensor, and/or the like) that may be operable to emit a laser or other light onto the surface of the semiconductor workpiece 214 and scan the surface (e.g., based on reflections of the light) for height or depth measurements, topography measurements, etc. of the surface of the semiconductor workpiece 214. In the example in FIG. 4, the one or more displacement sensors 212a, 212b may be configured to measure an amount of movement that occurs between the semiconductor workpiece 214 and imaging device 402 and/or displacement sensor 212a, 212b. It should be understood that the one or more displacement sensors 212a, 212b may be any suitable sensor operable to obtain displacement data described herein for generating the shape model or semiconductor workpiece displacement information for the semiconductor workpiece 214 without deviating from the scope of the present disclosure.

The first light source 404 may direct first incident light 410 onto a first portion of the semiconductor workpiece 214. Additionally or alternatively the second light source 422 may direct second incident light 414 onto a second portion of the semiconductor workpiece 214. The first and second portions of the semiconductor workpiece 214 may be the same portion or they may be different. The semiconductor workpiece 214 may direct light at the first portion of the semiconductor workpiece 214 before, concurrent with, or after the second light source 422 directs the second incident light 414 at the second portion of the semiconductor workpiece 214.

The first incident light 410 may be reflected and/or transmitted by the semiconductor workpiece 214, resulting in first detectable light 412 that is detected by the first displacement sensor 212a. The second incident light 414 may be reflected and/or transmitted by the semiconductor workpiece 214, resulting in second detectable light 416 that is detected by the second detector 416. First detectable light 412 and second detectable light 414 is illustrated as reflected light for purposes of illustration and discussion. Those having ordinary skill in the art, using the disclosures provided herein, will understand that the first detectable light 412 and/or second detectable light may be transmitted light. Additionally or alternatively, the first detectable light 412 and/or the second detectable light 416 may be emitted by the semiconductor workpiece 214 as photoluminescence (e.g., fluorescence). For instance, the first incident light 410 and/or the second incident light 414 may excite respective portions of the semiconductor workpiece 214 and result in a delayed light emission by the semiconductor workpiece 214.

In some examples, the first incident light 410 and/or the second incident light 414 are transmitted through the semiconductor workpiece 214. For instance, the first incident light 410 and/or the second incident light 414 may include a wavelength of light or other aspect of light that allows the light to substantially pass through the semiconductor workpiece 214. For instance, in some examples, the first incident light 410 and/or the second incident light 414 comprises infrared light (e.g., near-infrared (NIR) light).

The first light source 404 and/or the second light source 422 may be configured to emit light that is polarized (e.g., elliptically, linearly) or unpolarized, pulsed or continuous, coherent or incoherent, visible or invisible, and/or light of one or more wavelengths or wavelength ranges.

The first imaging device 402 may obtain workpiece images from the surface of the semiconductor workpiece 214.

In some examples, the semiconductor workpiece imaging system 400 includes a fiducial structure 444 as discussed herein. The fiducial structure 444 may be on the semiconductor workpiece 214 and/or on a workpiece holder (not shown in FIG. 4, but see workpiece holder 548 of FIG. 5 and workpiece holder 700 in FIG. 7), as discussed herein.

As discussed, the semiconductor workpiece imaging system 400 may include a controller 432 (also referred to herein as control circuitry) that includes a memory 434 and a processor 438. The memory 434 may include one or more memory devices, and/or the processor 438 may include one or more processors. The processor 438 may include an electronic and/or hardware processor. The memory 434 may include non-transitory memory. The memory 434 may store computer-readable instructions that when executed by the processor 438 cause the memory 434 to perform one or more control functions, such as any of the functions described herein.

The controller 432 may be in communication with various other aspects of the semiconductor workpiece imaging system 400 through one or more wired and/or wireless control links, such as the communication interface 430. The communication interface 430 may be a wired and/or wireless data communication link informationally connecting the first imaging device 402 (e.g., via the first displacement sensor 212a), the second imaging device (e.g., via the second detector 416), and/or the controller 432. The controller 432 may send control signals to the various components of the semiconductor workpiece imaging system 400 (e.g., the workpiece holder, the imaging device(s) 402, etc.) to implement the aspects of the present disclosure described herein. Additionally, the controller 432 may include one or more shape models or semiconductor workpiece displacement information for focusing, analyzing, processing, inspecting and/or characterizing the semiconductor workpiece 214, as described herein.

The controller 432 may be positioned at various locations with respect to an semiconductor workpiece system or imaging system (e.g., semiconductor workpiece system 300 (FIG. 3) or semiconductor workpiece imaging system 400 (FIGS. 4-5) to collect displacement data, generate the shape model or semiconductor workpiece displacement information, and/or focus the image device using the shape model or semiconductor workpiece displacement information, process image data, etc.

Yet another example that includes additional components is shown in FIG. 5. FIG. 5 depicts an example semiconductor workpiece imaging system 400 according to example embodiments of the present disclosure. The semiconductor workpiece imaging system 400 may include a birefringent contrast imaging device 502 and a photoluminescence imaging device 520. It should be understood that FIG. 5 is intended to represent structures for purposes of identification and description and is not intended to represent the structures to physical scale.

The semiconductor workpiece imaging system 400 of FIG. 5 can include controller 532 comprising the functionality of computing device 202 and first and/or second displacement sensors 212a, 212b to collect the displacement data, generate the shape model or semiconductor workpiece displacement information, and/or focus the image device 502 on the semiconductor workpiece 214 using the shape model for the semiconductor workpiece 214. Additionally or alternatively, the shape model and/or the semiconductor workpiece displacement information of the semiconductor workpiece 214 may be used, for example, to process, analyze, and/or inspect semiconductor workpiece 214.

As shown, the semiconductor workpiece imaging system 400 may include the birefringent contrast imaging device 502, the photoluminescence imaging device 520, the semiconductor workpiece 214, the workpiece holder 548, and/or the controller 532. The birefringent contrast imaging device 502 may include an infrared light source 504 and a first displacement sensor 212a. In some examples, the birefringent contrast imaging device 502 includes certain beam-modifying optical elements configured to control a beam shape, size, direction, and/or other aspect of the beam characteristics.

As discussed above, the semiconductor workpiece imaging system 400 can include one or more displacement sensors 212a, 212b for obtaining displacement data associated with the semiconductor workpiece 214.

In some embodiments, the one or more displacement sensors 212a, 212b may include depth sensors such as one or more surface measurement lasers or other illuminators (e.g., CCS) or sensors (e.g., white light interferometer sensor, a laser sensor, and an ultrasonic sensor, and/or the like) that may be operable to emit a laser or other light onto the surface of the semiconductor workpiece 214 and scan the surface (e.g., based on reflections of the light) for height or depth measurements, topography measurements, etc. of the surface of the semiconductor workpiece 214. The one or more displacement sensors 212a, 212b may be configured to measure an amount of movement that occurs between the semiconductor workpiece 214 and imaging device 502, 520 and/or displacement sensor 212a, 212b. It should be understood that the one or more displacement sensors 212a, 212b may be any suitable sensor operable to obtain displacement data described herein for generating the shape model or semiconductor workpiece displacement information for the semiconductor workpiece 214 without deviating from the scope of the present disclosure.

The infrared light source 504 may be configured to generate and direct incident polarized light 510 at the semiconductor workpiece 214. The infrared light source 504 may include a coherent light source, such as a laser. The infrared light source 504 may output infrared light, such as NIR light. The incident polarized light 510 may be linearly or circularly polarized light. In some examples, the infrared light source 504 may be configured to output despeckled light. For instance, the birefringent contrast imaging device 502, 520 may include a spatial filter, such as a pinhole or a diffuser. The spatial filter may remove high spatial frequency components of the incident polarized light 510 resulting in a despeckled output. Additionally or alternatively, the birefringent contrast imaging device 502, 520 may introduce controlled fluctuations in the phase or frequency of the incident polarized light 510 over time. This may provide temporal disruptions to the coherence of the incident polarized light 510. Other methods are possible.

The incident polarized light 510 may be used to image and/or characterize one or more surfaces (e.g., front surface proximal to the first displacement sensor 212a as shown, back surface proximal to the infrared light source 504 as shown). The incident polarized light 510 may be at least partially transmitted through the semiconductor workpiece 214 as shown, resulting in transmitted light 512 that may be captured by the first displacement sensor 212a. The transmitted light 512 may contain information about the one or more surfaces of the semiconductor workpiece 214.

In some examples, one or more of the birefringent contrast imaging device 502 and/or the photoluminescence imaging device 520 is configured to generate a darkfield image. Additionally or alternatively, the semiconductor workpiece imaging system 400 may generate a brightfield image using reflected light (e.g., in the birefringent contrast imaging device 502 and/or the photoluminescence imaging device 520). It should be understood that other imaging devices may be used without deviating from the scope of the present disclosure.

The infrared light source 504 may be configured (e.g., controlled by the controller 532) to focus the incident polarized light 510 at a target x-, y-, and z-position on or within the semiconductor workpiece 214.

The semiconductor workpiece imaging system 400 may additionally or alternatively include a workpiece support or workpiece holder 548. The workpiece holder 548 may be configured to support the semiconductor workpiece 214. The workpiece support may include a chuck (e.g., a vacuum chuck) or other mechanism to secure the semiconductor workpiece 214 during processing by the semiconductor workpiece imaging system 400. Additionally or alternatively, in some implementations, the workpiece holder 548 may provide a surface on which the semiconductor workpiece 214 rests. In some implementations, the workpiece holder 548 may provide for moving, rotating, angling, or otherwise reorienting the semiconductor workpiece 214 relative to the rest of the semiconductor workpiece imaging system 400. In some examples, the workpiece holder 548 provides a support surface along a peripheral edge of the semiconductor workpiece 214 so that light or other radiation may be transmitted through the semiconductor workpiece 214 without obstruction by the workpiece holder 548. In some examples, the semiconductor workpiece imaging system 400 may include a workpiece handling robot operable to move the workpiece to the workpiece holder 548.

The controller 532 may be positioned at various locations with respect to an semiconductor workpiece system or imaging system (e.g., semiconductor workpiece system 300 (FIG. 3) or semiconductor workpiece imaging system 400 (FIGS. 4-5) to collect displacement data, generate the shape model or semiconductor workpiece displacement information, focus the image device using the shape model, process image data, etc.

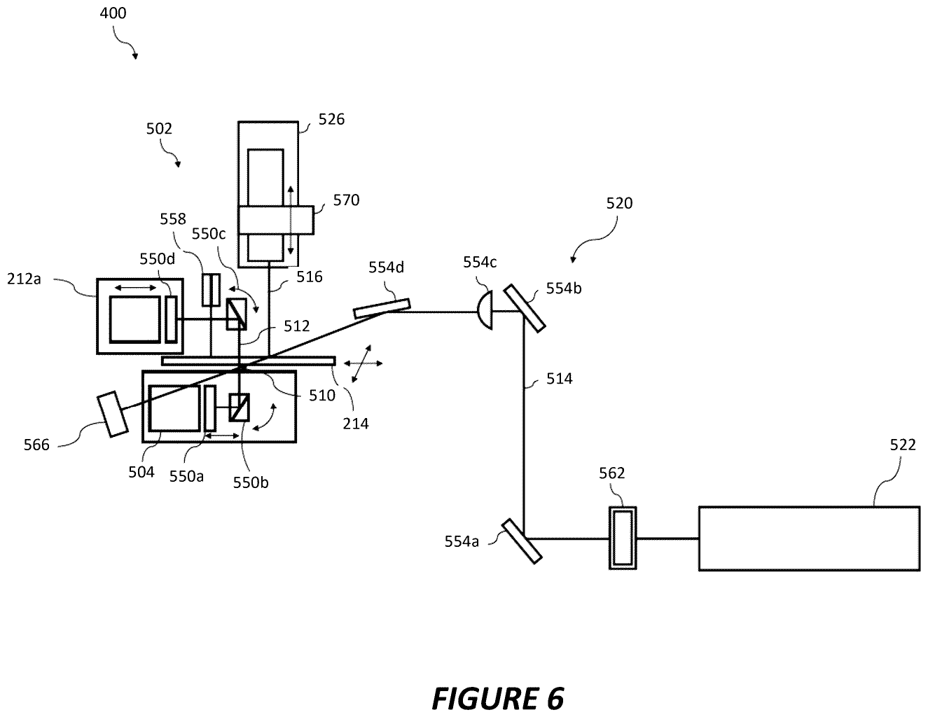

Another example that includes additional components is shown in FIG. 6. FIG. 6 depicts the example semiconductor workpiece imaging system 400 described above with reference to FIG. 5 according to example embodiments of the present disclosure. As shown, the semiconductor workpiece imaging system 400 includes a birefringent contrast imaging device 502 and a photoluminescence imaging device 520. The birefringent contrast imaging device 502 includes an infrared light source 504, a first displacement sensor 212a, one or more first optical elements 550a-d, an illuminator 558, and/or a power meter 566. However, although not depicted, it should be understood that the birefringent contrast imaging device 502 may have other suitable optical configurations, such as, by way of non-limiting example, using telecentric lenses and/or mirrors to accommodate capturing one or more images of on-axis and/or off-axis workpieces. Furthermore, in some examples, the photoluminescence imaging device 520 additionally or alternatively includes a power meter 566.

The semiconductor workpiece imaging system 400 of FIG. 6 can include a controller (not shown) comprising the functionality of computing device 202 and first and/or second displacement sensors 212a, 212b to collect the displacement data, generate the shape model or semiconductor workpiece displacement information, and/or focus the image device 502 on the semiconductor workpiece 214 using the shape model for the semiconductor workpiece 214. The shape model of the semiconductor workpiece 214 or semiconductor workpiece displacement information may be used, for example, to focus imaging device 502 and/or to process, analyze, and/or inspect semiconductor workpiece 214.

The semiconductor workpiece imaging system 400 of FIG. 6 can include displacement sensor 212a for obtaining displacement data associated with the semiconductor workpiece 214.

In some embodiments, the displacement sensor 212a includes a depth sensor such as one or more surface measurement lasers or other illuminators (e.g., CCS) or sensors (e.g., white light interferometer sensor, a laser sensor, and an ultrasonic sensor, and/or the like) that may be operable to emit a laser or other light onto the surface of the semiconductor workpiece 214 and scan the surface (e.g., based on reflections of the light) for height or depth measurements, topography measurements, etc. of the surface of the semiconductor workpiece 214. The displacement sensor 212a may be configured to measure an amount of movement that occurs between the semiconductor workpiece 214 and imaging device 502, 520 and/or displacement sensor 212a. It should be understood that the displacement sensor 212a may be any suitable sensor operable to obtain displacement data described herein for generating the shape model for the semiconductor workpiece 214 without deviating from the scope of the present disclosure.

As shown in FIG. 6, the infrared light source 504 may be configured to be movable along an x-axis. In some examples, the infrared light source 504 is moveable along two or three axes. This movement allows the controller (not shown) to focus the incident polarized light 510 onto the target location on or within the semiconductor workpiece 214, as well as to scan the semiconductor workpiece 214 along one or more target axes. Additionally or alternatively, the birefringent contrast imaging device 502 may include one or more first optical elements 550a-d that may aid in movement, beam characteristics, and/or focusing of the incident polarized light 510. For instance, the optical element 550a may include a polarizing element, such as a polarizer. The polarizing element may include a waveplate (e.g., half waveplate, quarter waveplate) and/or a polarizing beamsplitter. In some examples, the optical element 550a may include an optical filter. Such an optical filter may, for instance, be used to select for a particular wavelength of infrared (e.g., near infrared) light that will image the features on or within the semiconductor workpiece 214.

Additional optical elements, such as the optical element 550b and/or the optical element 550c may be included to control the beam of the incident polarized light 510. The optical element 550b and/or the optical element 550c may include reflective elements, such as mirrors and/or beamsplitters. As indicated in FIG. 6, one or more of the optical elements 550b, 550c may be configured to rotate along one or more axes. Additionally or alternatively, they may be able to translate along one or more axes. Such degrees of freedom may allow for a high level of precision in directing the beam path through and to focus the beam at the target location of the semiconductor workpiece 214. It may be advantageous to effectively rotate the incident polarized light 510 by a target amount (e.g., 90 degrees). For instance, it may be helpful to change which portion of the incident polarized light 510 is the ordinary and which is the extraordinary relative to the particular orientation of the semiconductor workpiece 214. In some examples, it may be possible to simultaneously image the same location of the semiconductor workpiece 214 along both axes, perhaps using a polarizing beamsplitter to direct both ordinary and extraordinary beams at the same target location simultaneously.

In some examples, the optical elements 550b, 550c include compensators, such as retardation plates. The compensators may introduce a controlled phase delay between the orthogonal components of the incident polarized light 510. Additionally or alternatively, they may adjust the relative phase between the ordinary and extraordinary rays passing through the semiconductor workpiece 214. This may allow for the observation of interference patterns and enhancing contrast of any features in the semiconductor workpiece 214.

The optical element 550d may include another polarizer. For instance, the optical element 550d may include an analyzer. The optical element 550d may be oriented at a specific angle relative to another polarizer (e.g., the optical element 550a) in the illumination path to provide a visualization of features in the semiconductor workpiece 214. This may be achieved by selectively transmitting the parts of the transmitted light 512 that have been modified by features in the semiconductor workpiece 214 in the polarization state.

In some examples, the birefringent contrast imaging device 502 may include an illuminator 558. The illuminator 558 may be configured to illuminate a surface of the semiconductor workpiece 214. The illuminator 558 may be configured to output visible light, but other wavelength ranges are also possible. The illuminator 558 may emit light suitable to facilitate capturing line scan images of the workpiece 214.

The photoluminescence imaging device 520 may include an ultraviolet light source 522, a photoluminescence detector 526, one or more second optical elements 554a-d, a light attenuator 562, and/or an optical filter 570. The ultraviolet light source 522 may include a coherent light source, such as a laser. In some examples, the light attenuator 562 may be included to help modulate (e.g., reduce) an intensity of the ultraviolet light source 522. This may be valuable, for instance, in situations where the laser output of the ultraviolet light source 522 is too strong for the semiconductor workpiece 214 or if precise control over the laser power is needed. Damaging the semiconductor workpiece 214 due to a laser intensity would be counterproductive to identifying and mitigating defects or other features on or in the semiconductor workpiece 214. The light attenuator 562 may absorb and/or scatter a portion of the laser light passing therethrough. This may reduce the beam intensity without significantly altering its properties such as its spatial and temporal characteristics.

In some examples, the photoluminescence imaging device 520 includes one or more of the second optical elements 554a-d shown. The optical elements 554a, 554b, 554d may include reflective optical elements, such as mirrors (e.g., dielectric mirrors, dichroic mirrors). The reflective optical elements may be configured to reflect a particular wavelength or range of wavelengths. The optical element 554c may be a refractive optical element, such as a lens. The lens may be configured to be a focusing lens and/or a collimating lens. The second optical elements 554a-d may be helpful in controlling a shape, direction, and/or other characteristics of the beam of light from the ultraviolet light source 522. In some examples, the controller (not shown) may automatically control one or more of the second optical elements 554a-d (and/or the first optical elements 550a-d).

The photoluminescence detector 526 may be configured to detect photoluminescence, such as fluorescence. The photoluminescence detector 526 may include one or more of photomultiplier tubes, avalanche photodiodes, a CCD sensor, and/or a CMOS sensors. The photoluminescence detector 526 may be configured to detect one or more ranges of fluorescence, such as about 400-450 nm (e.g., blue emissions), about 500-600 nm (e.g., green emissions), about 600-700 nm (e.g., red emissions), about 700-3100 nm (e.g., infrared emissions). As indicated in FIG. 6, the photoluminescence detector 526 may be configured to be movable along one or more degrees of freedom. For instance, the photoluminescence detector 526 may be translatable along a z-axis. Other degrees of freedom, such as x-and/or y-axis translations may be possible. In some examples, the photoluminescence detector 526 may be rotated along one or more of the x-, y-, and/or z-axis. The controller may be configured to control these movements.

In some examples, the photoluminescence detector 526 may include the optical filter 570. The optical filter 570 may include a filter wheel including a plurality of optical filters, such as wavelength range filters. The optical filter 570 may be controllable by the controller. In some examples, the optical filter 570 includes filters for one or more of the ranges of fluorescence (e.g., blue fluorescence, green fluorescence, red fluorescence, infrared fluorescence) described above.

In some examples, the semiconductor workpiece imaging system 400 may include the power meter 566. The power meter 566 may measure and in some examples control (e.g., at the direction of the controller) a power output by the infrared light source 504 and/or from the ultraviolet light source 522.

The controller (not shown in FIG. 6) may be positioned at various locations with respect to an semiconductor workpiece system or imaging system (e.g., semiconductor workpiece system 300 (FIG. 3) or semiconductor workpiece imaging system 400 (FIGS. 4-5) to collect displacement data from at least one displacement sensor 212, generate the shape model or semiconductor workpiece displacement information, and/or focus the image device using the shape model, semiconductor workpiece displacement information, process image data, etc.

Although some embodiments are described in the context of displacement data that includes variations in a height across a first surface of a semiconductor workpiece, it will be appreciated that aspects of the inventive concepts may be applicable to other types of displacement data in semiconductor workpieces, such as other dimensions or variations of warped or bowed semiconductor workpieces, among others.

Further, although some embodiments are described in the context of a semiconductor workpiece system of a semiconductor imaging system involving an imaging device, it will be appreciated that aspects of the inventive concepts may be applicable to other types of equipment or systems for semiconductor workpieces including, without limitation, semiconductor manufacturing equipment, such as processing equipment, inspection equipment, or other systems that analyze or use image data for a semiconductor workpiece and/or generate a shape model of a semiconductor workpiece.

As used herein, an “image” is any two-dimensional representation of displacement data. Displacement data that is spatially coordinated (e.g., to an x and y position of a workpiece) may be referred to as an image. A “composite image” may be an image that combines data from two or more sources. Generating a shape model does not require actual rendering of displacement data in a visual form, but rather generating and/or storing a shape model/image based on multiple sources of data, such as semiconductor workpiece displacement information. Furthermore, “images” may be categorized and/or distinguished based on a corresponding “image modality” which, as used herein, refers to a method, technique, and/or principle used to obtain the “image.” By way of non-limiting example, a “microscope image” refers to an image captured by a microscope modality; and a “birefringent contrast image” refers to an image captured in a birefringent contrast image modality. Likewise, a “photoluminescence image” refers to an image captured in a photoluminescence image modality. Although generally discussed with reference to microscope images, birefringent contrast images and photoluminescence images, those having ordinary skill in the art, using the disclosures provided herein, will understand that example aspects of the present disclosure may be applied to any suitable image in any suitable image modality without deviating from the scope of the present disclosure.

An example method for generating a shape model for a semiconductor workpiece is discussed with reference to FIGS. 7-15.

FIG. 7 illustrates five example sample lines 704a, 704b, 704c, 704d, 704e of a pattern 704 extending across a semiconductor workpiece 214 (a 150 mm wafer in this example) along which a series of continuous displacement sensor scans are performed. As shown, the five sample lines 704a, 704b, 704c, 704d, 704e include: area representing the extreme edges of the wafer 214; and area where the transition from the semiconductor workpiece holder 700 to the wafer 214 edge can be detected well (e.g., the four reference marks 706a, 706b, 706c, 706d). While the center of wafer 214 is included on sample line 704c, a sample line that includes the center of the wafer may be omitted. It is noted that while pattern 704 in this example includes five sample lines, other patterns may be used, such as two lines, a spiral pattern, a triangle pattern, other line patterns, among others. Moreover, while FIG. 7 includes four reference marks 704a, 704b, 704c, 704d, 704e shaped like holes, other amounts or shapes of reference marks may be used, such as two or more reference marks of any acceptable shape.

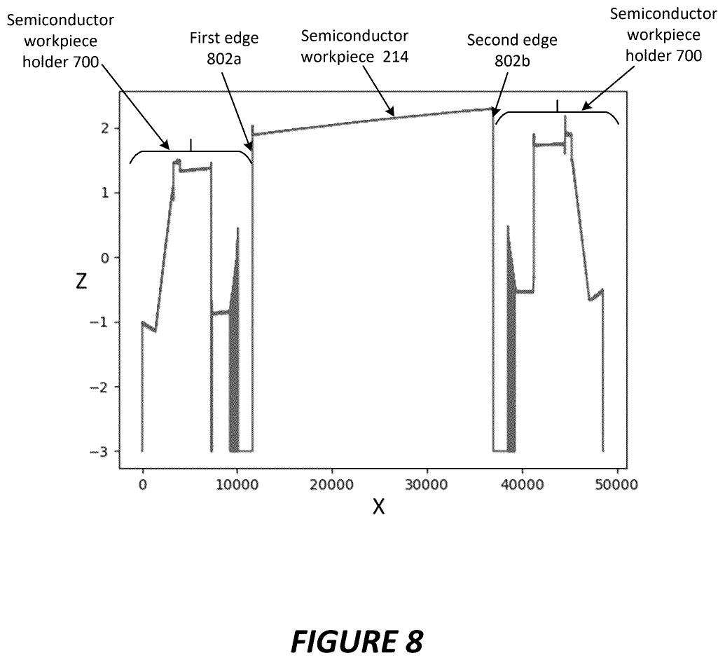

FIG. 8 is a graph that illustrates an example of one line scan of displacement data collected along sample line 704c. X represents the displacement along the wafer axis, and the “Z” value represents the value of height data read by the displacement sensor. As shown, the flat portion in the center of the graph is the wafer 214. First edge 802a and second edge 802b of the wafer 214 also are shown. This line scan also includes sharp transitions at first edge 802a and second edge 802b. The sharp transitions represent a portion of the semiconductor workpiece holder 700 to the left of first edge 802a and another portion of the semiconductor workpiece holder 700 to the right of second edge 802b.

In this example, data with sharp transitions to the first edge 802a and second edge 802b of the wafer 214, from one or more of the five continuous displacement sensor line scans along samples lines 704a, 704b, 704c, 704d, 704c is used to fit a shape to the semiconductor workpiece 214 based on the displacement data, In this example, an optimal circle is fit to the wafer 214. FIG. 10 illustrates a circle fit 1000 to the wafer 214 using at least the detected first edge 802a and second edge 802b. In some embodiments, the center of the circle can be used to identify other areas of wafer 214 that need to be modeled for height. In the example shown in FIG. 10, the heights of first and second fiducial markers 444a, 444b under the lines is additionally sampled.

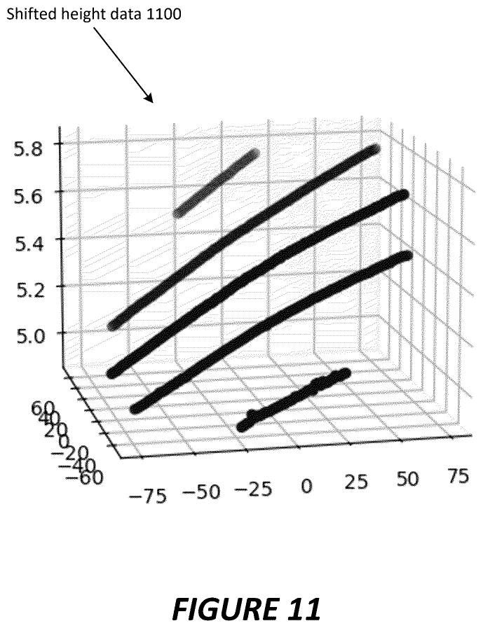

In, this example, the coordinate system of the height data is shifted such that the center of the circle is 0,0. FIG. 11 is a plot of the shifted height data 1100 such that the center of the wafer 214 is 0,0. This operation is included in order to perform a polar coordinate transform discussed further herein with respect to this example. As shown in FIG. 11, the X and Y axes go from −75 to +75 for this 350 mm wafer 214.

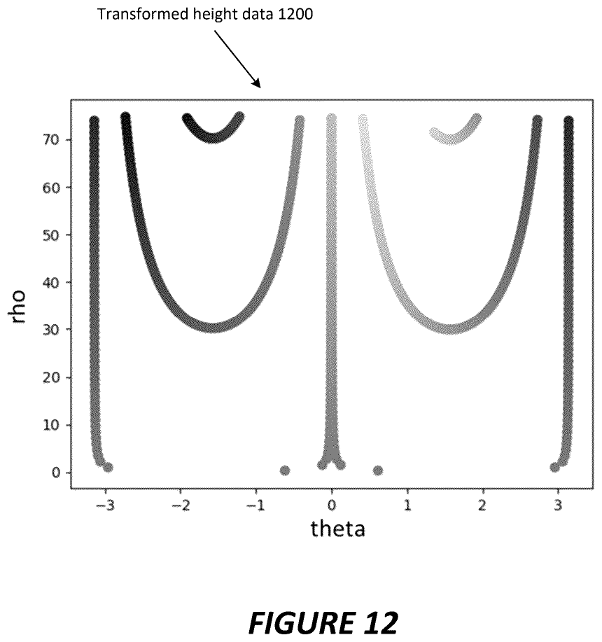

In this example, the height data's X and Y positions are converted from cartesian coordinates to polar coordinates. FIG. 12 is a plot of the height data 1100 from FIG. 11 transformed into height data 1200 with polar coordinates.

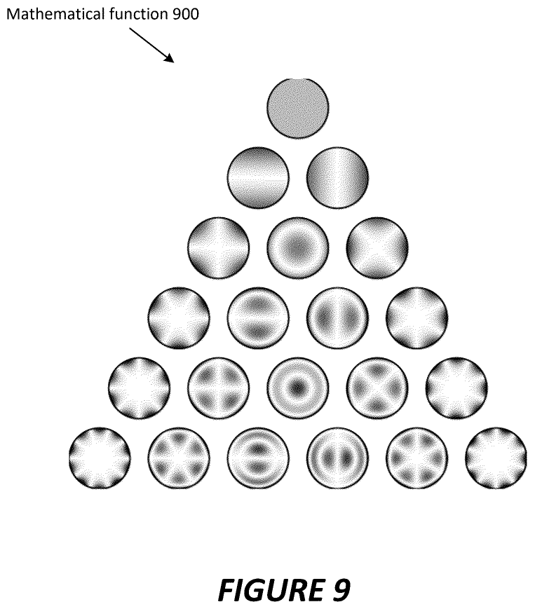

A mathematical function, specifically a Zernike polynomial of arbitrary/defined order, in this example, is fit to the polar-converted height data 1200. FIG. 9 illustrates an example of Zernike polynomials. Those having ordinary skill in the art, using the disclosures provided herein, will appreciate that Zernike polynomials are a sequence of polynomials that are orthogonal on a unit disk. Zernike polynomials may be used in various optics branches such as beam optics and imaging. FIG. 9 shows the first twenty-one (21) Zernike polynomials, ordered vertically by radial degree and horizontally by azimuthal degree.

In this example, a Zernike polynomial of order 12 is fit to the polar-converted height data 1200. In performing the fit, a least squares process can be used and/or an outlier robust process such as a random sample consensus (RANSAC), for example. If any other areas of wafer 214 need to be focus mapped, separate functions can be fit to these areas. In this example, a plan was fit to the first and second fiducial marker lines 444a, 444b in FIG. 10.

The fit Zernike polynomial function, in this example, was sampled on a desired grid (polar to cartesian translation in this example). Additional areas of wafer 214 with their appropriate functions can be sampled as well, including copying the data if necessary to other areas.

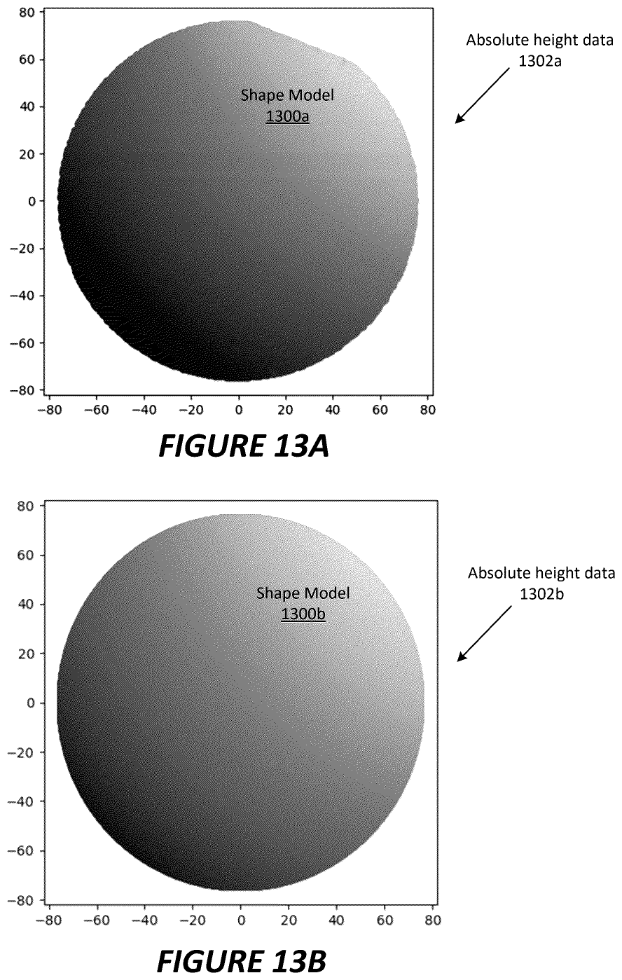

FIG. 13A illustrates absolute height data 1302a from a dense scan of the wafer 214 in this example. This absolute height data 1302a is ground truth and took about thirty (30) minutes to gather.

FIG. 13B illustrates a reconstruction 1300b (also referred to herein as shape model 130b) from five swaths of data, taken in around fifteen (15) seconds. Error included in this reconstruction is about ±4.5 μm after removal of outliers (that is, defects in the collected data that an autofocus system should not respond to, for example).

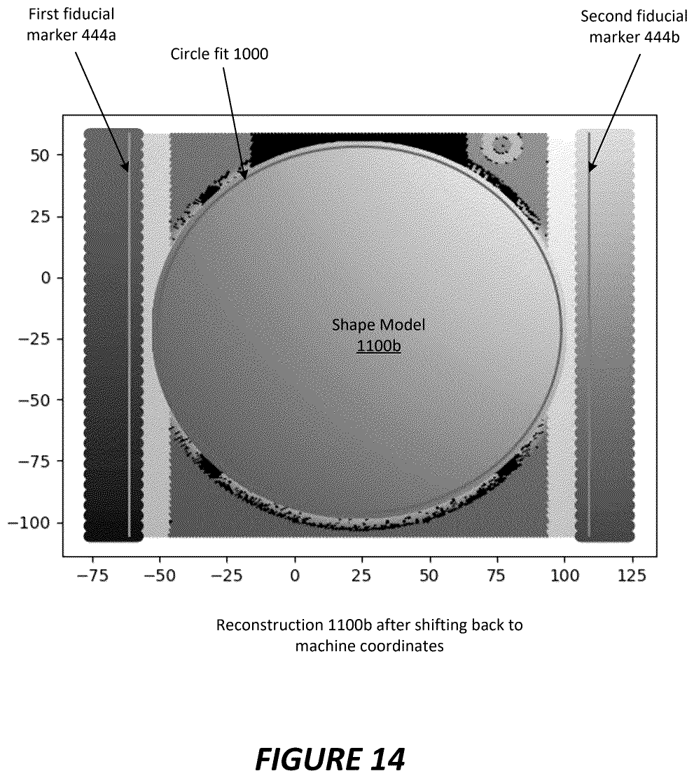

The reconstruction 1300b was shifted back to machine absolute coordinates. The reconstruction 1300b after shifting back to machine coordinates, with appended data from sampled fiduciary markers 444a, 444b, is shown in FIG. 14.

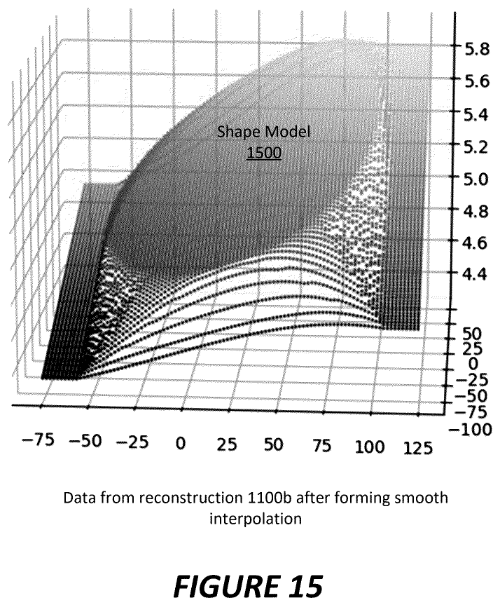

A smooth interpolation was performed between the wafer function and any additional areas that needed to be in focus. FIG. 15 illustrates shape model 1500 from FIG. 14 after forming the smooth interpolation. The data 1500 from FIG. 15 may be fed into a trajectory generator for an autofocus system, for example.

The shape model may include a focus map of the semiconductor workpiece. In some embodiments, the shape model includes image data of the semiconductor workpiece.

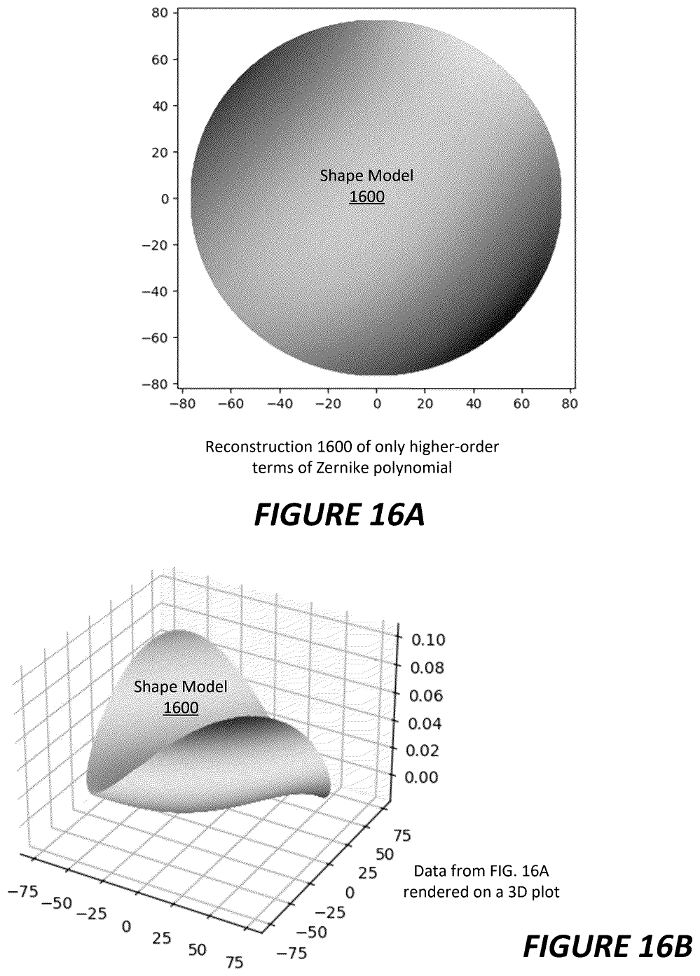

Alternatively or additionally, a shape model may be used to estimate wafer warp or bow, for example. In one example, if the piston (tilt X, and tilt Y terms) are removed from the Zernike polynomial, the resulting polynomial can be used to obtain a fast estimate of wafer 214 warp and bow, as well as other shape characteristics. FIG. 16A illustrates an example of a shape model 1600 of only higher-order terms of Zernike polynomial, allowing the wafer 214 shape to be seen, while ignoring machine tilt or absolute displacement. FIG. 16B illustrates data from model 1600 of FIG. 16A rendered on a three-dimensional (3D) plot. Fine details of the shape of the wafer 214 can be seen (e.g., warp/bow).

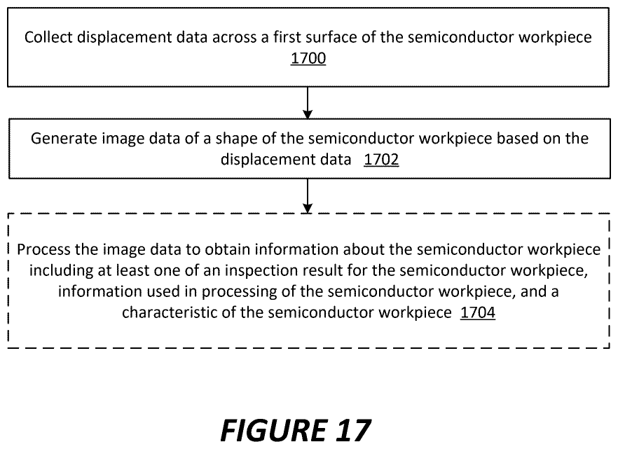

FIG. 17 depicts an illustrative example of a method of generating image data of a semiconductor workpiece 214. FIG. 17 depicts example process steps for purposes of illustration and discussion. Those having ordinary skill in the art, using the disclosures provided herein, will understand that the process steps of any of the methods described in the present disclosure may be adapted, modified, include steps not illustrated, omitted, and/or rearranged without deviating from the scope of the present disclosure.

At 1700, displacement data is collected across a first surface of the semiconductor workpiece 214. Collecting the displacement data may include collecting data in an approximately continuous manner across the first surface of the semiconductor workpiece 214. Collecting the displacement data may further include collecting the displacement data from a plurality of line scans across the first surface of the semiconductor workpiece 214. The plurality of line scans may include at least two line scans across the first surface of the semiconductor workpiece.

At 1702, image data is generated of a shape of the semiconductor workpiece 214 based on the displacement data. Generating the image data may include fitting a shape to the semiconductor workpiece 214 based on the displacement data; fitting a mathematical function to height data from the displacement data; and forming a smooth interpolation between the mathematical function and an additional area of the semiconductor workpiece 214 for inclusion in the image data.

The mathematical function may include a Zernike polynomial of a defined order. Fitting the mathematical function may be based on at least one of a least squares process and a RANSAC.

Generating 1702 the image data may further include shifting the height data such that a center of the semiconductor workpiece has a cartesian coordinate position of zero on a first cartesian axis and zero on a second cartesian axis; and converting the cartesian coordinate positions of the height data to polar coordinates to obtain polar-converted height data.

Generating 1702 the image data may further include sampling the fitted mathematical function on a defined coordinate system; and shifting the defined coordinate system to absolute coordinates of the imaging device in which the semiconductor workpiece is positioned.

The image data may include a focus map of the semiconductor workpiece 214 for use by a controller in focusing on the semiconductor workpiece 214. In another embodiment, the image data for the semiconductor workpiece 214 is used in a semiconductor processing system.

In some embodiments, the Zernike polynomial includes a first tilt along a first cartesian axis and a second tilt along a second cartesian axis, and the method further includes removing the first tilt and the second tilt from the Zernike polynomial to obtain an estimate of at least one of a warp and a bow of the semiconductor workpiece.

In some embodiments, at 1704, the method further includes processing the image data to obtain information about the semiconductor workpiece including at least one of an inspection result for the semiconductor workpiece, information used in processing of the semiconductor workpiece, and a characteristic of the semiconductor workpiece.

The characteristic of the semiconductor workpiece may include at least one of a warp and a bow of the semiconductor workpiece with a tilt of the semiconductor workpiece removed.

The inventive concepts have been described above with reference to the accompanying drawings, in which embodiments are shown. The inventive concepts may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. It will be understood that when an element or layer is referred to as being “on”, “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items. Like numbers refer to like elements throughout, except where expressly noted.

It will be understood that although the terms first and second are used herein to describe various regions and/or elements, these regions and/or elements should not be limited by these terms. These terms are only used to distinguish one region or element from another region or element. Thus, a first region or element discussed herein could be termed a second region or element, and similarly, a second region or element may be termed a first region or element without departing from the scope of the present invention.

Relative terms, such as “lower” or “bottom” and “upper” or “top,” may be used herein to describe one element's relationship to another element as illustrated in the drawings. It will be understood that relative terms are intended to encompass different orientations of the device in addition to the orientation depicted in the drawings. For example, if the apparatus in the drawings is turned over, elements described as being on the “lower” side of other elements would then be oriented on “upper” sides of the other elements. The exemplary term “lower” can, therefore, encompass both an orientation of “lower” and “upper,” depending of the particular orientation of the figure. Similarly, if compartments of the apparatus in one of the figures is turned over, elements described as “below” or “beneath” other elements would then be oriented “above” the other elements. The exemplary terms “below” or “beneath” can, therefore, encompass both an orientation of above and below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, elements, and/or components, but do not preclude the presence or addition of one or more other features, elements, components, and/or groups thereof.

Embodiments of the inventive concepts are described herein with reference to cross-sectional illustrations that are schematic illustrations. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, a scaling component illustrated as a circle will, typically, have straight or other features and/or a shape to exclude a wafer notch. Thus, the components, such as the sealing component, illustrated in the figures are schematic in nature and their shapes are not intended to illustrate the actual shape of a component of an apparatus and are not intended to limit the scope of the invention.

It will be understood that the embodiments disclosed herein can be combined. Thus, features that are pictured and/or described with respect to a first embodiment may likewise be included in a second embodiment, and vice versa.

While the above embodiments are described with reference to particular figures, it is to be understood that some embodiments of the present invention may include additional and/or intervening component, structures, or elements, and/or particular components, structures, or elements may be deleted. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A method of generating a shape model of a semiconductor workpiece, the method comprising:
collecting displacement data across a first surface of the semiconductor workpiece; and
generating the shape model for the semiconductor workpiece based on the displacement data.

2. The method of claim 1, further comprising:
focusing an image device using the shape model for the semiconductor workpiece.

3. The method of claim 1, wherein the displacement data is collected from a plurality of line scans across the first surface of the semiconductor workpiece.

4. The method of claim 1, wherein the collecting comprises collecting displacement data in an approximately continuous manner along the first surface of the semiconductor workpiece.

5. The method of claim 3, wherein the plurality of line scans includes at least two line scans across the first surface of the semiconductor workpiece.

6. The method of claim 1, wherein generating the shape model comprises:
fitting a shape to the semiconductor workpiece based on the displacement data;
fitting a mathematical function to height data from the displacement data; and
forming a smooth interpolation between the mathematical function and an additional area of the semiconductor workpiece for inclusion in the shape model.

7. The method of claim 6, wherein the mathematical function comprises a Zernike polynomial of a defined order.

8. The method of claim 6, wherein fitting the mathematical function is based on at least one of a least squares process and a random sample consensus, RANSAC.

9. The method of claim 6, the method further comprising:
shifting the height data such that a center of the semiconductor workpiece has a cartesian coordinate position of zero on a first cartesian axis and zero on a second cartesian axis; and
converting the cartesian coordinate positions of the height data to polar coordinates to obtain polar-converted height data.

10. The method of claim 6, further comprising:
sampling the fitted mathematical function on a defined coordinate system; and
shifting the defined coordinate system to absolute coordinates of the imaging device in which the semiconductor workpiece is positioned.

11. The method of claim 1, wherein the shape model comprises a focus map of the semiconductor workpiece.

12. The method of claim 7, wherein the Zernike polynomial comprises a first tilt along a first cartesian axis and a second tilt along a second cartesian axis, the method further comprising:
removing the first tilt and the second tilt from the Zernike polynomial to obtain an estimate of at least one of a warp and a bow of the semiconductor workpiece.

13. The method of claim 1, wherein the shape model comprises image data of the semiconductor workpiece.

14. A semiconductor workpiece system comprising:
a workpiece holder configured to hold a semiconductor workpiece;
a displacement sensor configured to collect displacement data along a first surface of a semiconductor workpiece; and
control circuitry configured to generate a shape model of the semiconductor workpiece based on the displacement data.

15. The semiconductor workpiece system of claim 14, further comprising:
an image device configured to focus based on the shape model for the semiconductor workpiece.

16. The semiconductor workpiece system of claim 14, wherein the displacement sensor comprises a confocal chromatic sensor.

17. The semiconductor workpiece system of claim 14, wherein the displacement sensor comprises at least one of a white light interferometer sensor, a laser sensor, and an ultrasonic sensor.

18. The semiconductor workpiece system of claim 14, wherein the displacement data is collected from a plurality of line scans across the first surface of the semiconductor workpiece.

19. The semiconductor workpiece system of claim 14, wherein the displacement sensor is configured to collect displacement data in an approximately continuous manner along the first surface of the semiconductor workpiece.

20. The semiconductor workpiece system of claim 18, wherein the plurality of line scans includes at least two line scans across the first surface of the semiconductor workpiece.

21. The semiconductor workpiece system of claim 14, wherein generate the shape model comprises:
fit a shape to the semiconductor workpiece based on the displacement data;
fit a mathematical function to height data from the displacement data; and
form a smooth interpolation between the mathematical function and an additional area of the semiconductor workpiece for inclusion in the shape model.

22. The semiconductor workpiece system of claim 21, wherein the mathematical function comprises a Zernike polynomial of a defined order.

23. The semiconductor workpiece system of claim 21, wherein fit the mathematical function is based on at least one of a least squares process and a random sample consensus, RANSAC.

24. The semiconductor workpiece system method of claim 21, wherein the control circuitry in further configured to:
shift the height data such that a center of the semiconductor workpiece has a cartesian coordinate position of zero on a first cartesian axis and zero on a second cartesian axis; and
convert the cartesian coordinate positions of the height data to polar coordinates to obtain polar-converted height data.

25. The semiconductor workpiece system of claim 21, wherein the control circuitry is further configured to:
sample the fitted mathematical function on a defined coordinate system; and
shift the defined coordinate system to absolute coordinates of the imaging device in which the semiconductor workpiece is positioned.

26. The semiconductor workpiece system of claim 14, wherein the shape model comprises a focus map of the semiconductor workpiece.

27. The semiconductor workpiece system of claim 22, wherein the Zernike polynomial comprises a first tilt along a first cartesian axis and a second tilt along a second cartesian axis, and the control circuitry is further configured to:
remove the first tilt and the second tilt from the Zernike polynomial to obtain an estimate of at least one of a warp and a bow of the semiconductor workpiece.

28. The semiconductor workpiece system of claim 14, wherein the shape model comprises image data of the semiconductor workpiece.

29. A method of generating image data of a semiconductor workpiece, the method comprising:
collecting displacement data across a first surface of the semiconductor workpiece; and
generating the image data of a shape of the semiconductor workpiece based on the displacement data.

30. The method of claim 29, further comprising:
processing the image data to obtain information about the semiconductor workpiece comprising at least one of an inspection result for the semiconductor workpiece, information used in processing of the semiconductor workpiece, and a characteristic of the semiconductor workpiece.

31. The method of claim 30, wherein the characteristic of the semiconductor workpiece comprises at least one of a warp and a bow of the semiconductor workpiece with a tilt of the semiconductor workpiece removed.

32. A semiconductor workpiece system comprising:
a workpiece holder configured to hold a semiconductor workpiece;
a displacement sensor configured to collect displacement data along a first surface of a semiconductor workpiece; and
control circuitry configured to generate the image data of a shape of the semiconductor workpiece based on the displacement data.

33. The semiconductor workpiece system of claim 32, wherein the control circuitry is configured to process the image data to obtain information about the semiconductor workpiece comprising at least one of an inspection result for the semiconductor workpiece, information used in processing of the semiconductor workpiece, and a characteristic of the semiconductor workpiece.

34. The semiconductor workpiece system of claim 33, wherein the characteristic of the semiconductor workpiece comprises at least one of a warp and a bow of the semiconductor workpiece with a tilt of the semiconductor workpiece removed.

35. A method of focusing an imaging device on a semiconductor workpiece, the method comprising:
focusing the image device on the semiconductor workpiece using a shape model for the semiconductor workpiece based on displacement data, from a displacement sensor, across a first surface of the semiconductor workpiece.

36. The method of claim 35, wherein the shape model comprises a focus map of the semiconductor workpiece.

37. The method of claim 35, wherein the displacement data is collected from a plurality of line scans across the first surface of the semiconductor workpiece.

38. The method of claim 35, wherein the displacement data is approximately continuous along the first surface of the semiconductor workpiece.

39. The method of claim 37, wherein the plurality of line scans includes at least two line scans across the first surface of the semiconductor workpiece.

40. The method of claim 35, further comprising:
generating the shape model based on fitting a shape to the semiconductor workpiece based on the displacement data;
fitting a mathematical function to height data from the displacement data; and
forming a smooth interpolation between the mathematical function and an additional area of the semiconductor workpiece for inclusion in the shape model.

41. The method of claim 40, wherein the mathematical function comprises a Zernike polynomial of a defined order.

42. The method of claim 40, wherein fitting the mathematical function is based on at least one of a least squares process and a random sample consensus, RANSAC.

43. The method of claim 40, the method further comprising:
shifting the height data such that a center of the semiconductor workpiece has a cartesian coordinate position of zero on a first cartesian axis and zero on a second cartesian axis; and
converting the cartesian coordinate positions of the height data to polar coordinates to obtain polar-converted height data.

44. The method of claim 40, further comprising:
sampling the fitted mathematical function on a defined coordinate system; and
shifting the defined coordinate system to absolute coordinates of the imaging device in which the semiconductor workpiece is positioned.

45. The method of claim 41, wherein the Zernike polynomial comprises a first tilt along a first cartesian axis and a second tilt along a second cartesian axis, the method further comprising:
removing the first tilt and the second tilt from the Zernike polynomial to obtain an estimate of at least one of a warp and a bow of the semiconductor workpiece.

46. A semiconductor workpiece imaging system comprising:
a workpiece holder configured to hold a semiconductor workpiece;
a displacement sensor configured to collect displacement data along a first surface of a semiconductor workpiece;
control circuitry configured to generate a shape model for the semiconductor workpiece based on the displacement data and to focus an image device on the semiconductor workpiece using the shape model for the semiconductor workpiece.

47. The semiconductor workpiece imaging system of claim 46, wherein the shape model comprises a focus map of the semiconductor workpiece.

48. The semiconductor workpiece imaging system of claim 46, wherein the displacement data is collected from a plurality of line scans across the first surface of the semiconductor workpiece.

49. The semiconductor workpiece imaging system of claim 46, wherein the collecting comprises collecting displacement data in an approximately continuous manner along the first surface of the semiconductor workpiece.

50. The semiconductor workpiece imaging system of claim 48, wherein the plurality of line scans includes at least two line scans across the first surface of the semiconductor workpiece.

51. The semiconductor workpiece imaging system of claim 46, wherein generate the shape model comprises:
fit a shape to the semiconductor workpiece based on the displacement data;
fit a mathematical function to height data from the displacement data; and
form a smooth interpolation between the mathematical function and an additional area of the semiconductor workpiece for inclusion in the shape model.

52. The semiconductor workpiece imaging system of claim 51, wherein the mathematical function comprises a Zernike polynomial of a defined order.

53. The semiconductor workpiece imaging system of claim 51, wherein fit the mathematical function is based on at least one of a least squares process and a random sample consensus, RANSAC.

54. The semiconductor workpiece imaging system of claim 46, wherein the control circuitry is further configured to:
shift the height data such that a center of the semiconductor workpiece has a cartesian coordinate position of zero on a first cartesian axis and zero on a second cartesian axis; and
convert the cartesian coordinate positions of the height data to polar coordinates to obtain polar-converted height data.

55. The semiconductor workpiece imaging system of claim 46, wherein the control circuitry is further configured to:
sample the fitted mathematical function on a defined coordinate system; and
shift the defined coordinate system to absolute coordinates of the imaging device in which the semiconductor workpiece is positioned.

56. The semiconductor workpiece imaging system of claim 52, wherein the Zernike polynomial comprises a first tilt along a first cartesian axis and a second tilt along a second cartesian axis, and the control circuitry is further configured to:
remove the first tilt and the second tilt from the Zernike polynomial to obtain an estimate of at least one of a warp and a bow of the semiconductor workpiece.
